(19) United States
(12) Patent Application Publication
(10) Pub. No.: US 2003/0006877 A1
(43) Pub. Date: Jan. 9, 2003

(54) Providing variable delays through stacked resistor pads

(75) Inventor: Ravdeep Singh Anand, Framingham, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Equipe Communications Corporation

(21) Appl. No.: 09/761,892

(22) Filed: Jan. 17, 2001

(51) Int. Cl. H01C 1/01

(52) U.S. Cl. 338/320

(57) ABSTRACT

The present invention provides a method and apparatus for providing variable signal delays through stacked resistor pads. Stacked resistor pads include resistor pads mounted on both sides of a module where at least certain resistor pads on one side of the module are electrically connected to certain other resistor pads on the other side of the module through shared vias. Stacked resistor pads reduce the number of connections and vias required by conventional resistor pad combinations. Reducing connections and vias reduces the capacitance added to the delayed signal, which reduces potential signal degradation, especially at high-speeds. In addition, connections and vias lower the potential for manufacturing defects and errors due to missing or broken parts. Moreover, stacked resistor pads consumes significantly less module surface space than currently available resistor pad combinations.

### BACKGROUND

Today's telecommunications network devices include complex, high-speed hardware. In general, the hardware includes large, multi-layer printed circuit boards (i.e., modules, cards) populated by many complex integrated circuit components such as large, custom gate arrays and processor components. Often the components operate at high-speeds, for example, greater than 100 MHz, and the clock and data signals between these components must be accurately timed in order for all the components to function properly.

When a component connected to both the data and clock signals detects the rising edge of the clock signal, it accepts the data signals, for example, by loading the data signals into internal registers. To insure data integrity, network designers typically want the rising edge of a clock signal to occur in the middle of a data pulse to meet necessary set up and hold times. During the design of a new network device, components the designers plan to use may also be in the process of being designed, and in such instances, the exact timing of data and clock signals may not be known. As a result, once the component is complete, the designer may need to shift the timing of the clock signal on the module to center the rising edge of the clock in the middle of the data pulse. Often the clock signal is shifted by adding delay to the clock signal etch on the module. Instead, the data signals may be shifted, however, it is easier to shift a single clock signal then multiple data signals.

Referring to FIG. 1a, variable delays may be added to a clock line 1102, 1102′ on a module 1103 through resistors placed in various combinations across resistor pads 1104a-1104p. The clock and delay lines are shown as dashed lines indicating that these lines may be routed on the top surface or on internal layers of module 1103. Clock line 1102 connects to a via 1108a which is connected to an output 1110a of a component 1112. Clock line 1102 also connects to a via 1108b as does resistor pad 1104a through an etch 1110b. On the output end of the resistor pads, clock line 1102′ connects to a via 1108c and to resistor pad 1104h through an etch 1110c. Clock line 1102′ also connects to a via 1108d and to an input 1110d of a component 1114.

Referring to FIG. 1b, the minimum delay across the resistor pads is accomplished by connecting resistor 1106a across resistor pads 1104a-1104b, resistor 1106b across pads 1104c-1104d, resistor 1106c across pads 1104e-1104f and resistor 1106d across pads 1104g-1104h. An etch 1116a connects vias 1108e and 1108fwhich are connected to resistor pads 1104b and 1104c. Thus, connecting resistor 1106a across pads 1104a and 1104b connects clock line 1102 through to resistor pad 1104c. Similarly, etch 1116b connects vias 1108g and 1108h which are connected to resistor pads 1104d and 1104e, respectively. Thus, connecting resistor 1106b across pads 1104c and 1104d connects clock line 1102 through to resistor pad 1104f. Etch 1116c connects vias 1108i and 1108j which are connected to resistor pads 1104f and 1104g, respectively. Thus, connecting resistor 1106c across pads 1104e and 1104f connects clock line 1102 through to resistor pad 1104g, and connecting resistor 1106d across pads 1104g and 1104h connects clock line 1102 through to clock line 1102′.

Although resistor pad 1104b is shown in close proximity to resistor pad 1104c, this is by way of example, and these two resistor pads may be located much further apart on module 1103. Similarly, resistor pads 1104d and 1104f may be located much further away from resistor pads 1104e and 1104g, respectively, than is shown.

Resistor pads 1104i-1104p may be used to add additional delay. For instance, resistor pad 1104i is connected to resistor pad 1104j through a delay line 1118a that adds, for example, a 250 ps delay. That is, the length of delay line 1118a is sufficient to add a delay of 250 ps. Referring to FIG. 1c, to add this delay to clock signal 1102, 1102′, resistor 1106a (FIG. 1b) is removed and a resistor 1106e is connected across resistor pads 1104a and 1104i and a resistor 1106f is connected across resistor pads 1104b and 1104j. Thus, delay line 1118a (e.g., 250 ps) is added between clock line 1102 and 1102′.

Resistor pads 1104k and 1104L are connected by a delay line 1118b (e.g., 500 ps), resistor pads 1104m and 1104n are connected by a delay line 1118c (e.g., 1000 ps), and resistor pads 1104o and 1104p are connected by a delay line 1118d (e.g., 1250 ps). Referring to FIG. 1d, instead of adding a 250 ps delay, a designer may add a 500 ps delay by leaving resistor 1106a connected across resistor pads 1104a and 1104b, removing resistor 1106b (FIG. 1b) and connecting a resistor 1106g across pads 1104c and 1104k and a resistor 1106h across pads 1104d and 1104L.

In addition, one or more delay lines 1118a-1118d may be added together. Referring to FIG. 1e, the maximum delay possible is the combination of each of delay lines 1118a-1118d (e.g., 3750 ps). This is accomplished by removing resistors 1106a-1106d (FIG. 1b) and connecting resistor 1106e across pads 1104a and 1104i, resistor 1106f across pads 1104b and 1104j, resistor 1106g across pads 1104c and 1104k, resistor 1106h across pads 1104d and 1104L, resistor 1106i across pads 1104e and 1104m, resistor 1106j across pads 1104f and 1104n, resistor 1106k across pads 1104g and 1104o, and resistor 1106L across pads 1104h and 1104p. Although delay lines 1118a-1118d are shown to be different lengths, they may be the same length to provide multiples of the same delay.

Through the sixteen resistor pads 1104a-1104p, fifteen different delays are possible using fifteen different resistor combinations, with the minimum delay requiring four resistors and the maximum delay requiring eight resistors. The more resistors, the higher the potential for an error such as a missing resistor or an improperly mounted resistor. If all of the resistor pad connections are routed on internal layers within module 1103, then each resistor pad requires a via to connect to its internal etch. The via attached to each resistor pad and the connections between each pair of resistor pads adds capacitance to the signal. At high-speeds (e.g., greater than 100 MHz), the added capacitance may quickly deteriorate the signal quality. Alternatively, the number of vias may be reduced by having surface etches connect the resistor pads. However, surface etches are susceptible to noise which may affect signal quality to a greater extent than the capacitance added by the vias. In addition, the combination of resistor pads consumes valuable surface space on module 1103.

### SUMMARY

The present invention provides a method and apparatus for providing variable signal delays through stacked resistor pads. Stacked resistor pads include resistor pads mounted on both sides of a module where at least certain resistor pads on one side of the module are electrically connected to certain other resistor pads on the other side of the module through shared vias. Stacked resistor pads reduce the number of connections and vias required by conventional resistor pad combinations. Reducing connections and vias reduces the capacitance added to the delayed signal, which reduces potential signal degradation, especially at high-speeds. In addition, connections and vias lower the potential for manufacturing defects and errors due to missing or broken parts. Moreover, stacked resistor pads consumes significantly less module surface space than currently available resistor pad combinations.

In one aspect, the present invention provides a stacked resistor pad combination comprising a first set of resistor pads on a first side of a module, including a first resistor pad electrically connected to a first via and a second resistor pad electrically connected to a second via, where the second resistor pad is located in proximity to the first resistor pad, and a second set of resistor pads on a second side of the module, including a third resistor pad electrically connected to the first via and a fourth resistor pad electrically connected to the second via, where the fourth resistor pad is located in proximity to the third resistor pad.

In another aspect, the present invention provides a stacked resistor pad combination comprising a first set of resistor pads on a first side of a module, including a first resistor pad electrically connected to a first via, where the first via is capable of being electrically connected to an output of a first component, a second resistor pad electrically connected to a second via, where the second via is capable of being electrically connected to an input of a second component and where the second resistor pad is located in proximity to the first resistor pad, a third resistor pad located in proximity to the first resistor pad and a fourth resistor pad located in proximity to the second resistor pad, where the third and fourth resistor pads are electrically connected through a delay line, and a second set of resistor pads on a second side of the module, including a fifth resistor pad electrically connected to the first via and a sixth resistor pad electrically connected to the second via, where the sixth resistor pad is located in proximity to the fifth resistor pad.

In yet another aspect, the present invention provides a stacked resistor pad combination comprising a first set of resistor pads on a first side of a module, including a first resistor pad electrically connected to a first via, where the first via is capable of being electrically connected to an output of a first component, and a second resistor pad electrically connected to a second via, where the second via is capable of being electrically connected to an input of a second component and where the second resistor pad is located in proximity to the first resistor pad, and a second set of resistor pads on a second side of the module, including a third resistor pad electrically connected to the first via, a fourth resistor pad electrically connected to the second via, where the fourth resistor pad is located in proximity to the third resistor pad, a fifth resistor pad located in proximity to the third resistor pad and a sixth resistor pad located in proximity to the fourth resistor pad, where the fifth and sixth resistor pads are electrically connected through a delay line.

In still another aspect, the present invention provides a stacked resistor pad combination comprising a first set of resistor pads on a first side of a module, including a first resistor pad electrically connected to a first via, where the first via is capable of being electrically connected to an output of a first component, a second resistor pad electrically connected to a second via, where the second via is capable of being electrically connected to an input of a second component and where the second resistor pad is located in proximity to the first resistor pad, a third resistor pad located in proximity to the first resistor pad, a fourth resistor pad located in proximity to the second resistor pad, where the third and fourth resistor pads are electrically connected through a first delay line, a fifth resistor pad located in proximity to the first resistor pad, a sixth resistor pad located in proximity to the second resistor pad, where the fifth and sixth resistor pads are electrically connected through a second delay line, and a second set of resistor pads on a second side of the module, including a seventh resistor pad electrically connected to the first via, an eighth resistor pad electrically connected to the second via, where the seventh resistor pad is located in proximity to the eighth resistor pad, a ninth resistor pad located in proximity to the seventh resistor pad, a tenth resistor pad located in proximity to the eighth resistor pad, where the ninth and tenth resistor pads are electrically connected through a third delay line, an eleventh resistor pad located in proximity to the seventh resistor pad and a twelfth resistor pad located in proximity to the eighth resistor pad, where the eleventh and twelfth resistor pads are electrically connected through a fourth delay line.

In another aspect, the present invention provides a stacked resistor pad combination comprising a first set of resistor pads on a first side of a module, including a first resistor pad electrically connected to a first via, a second resistor pad electrically connected to a second via, where the second resistor pad is located in proximity to the first resistor pad, a third resistor pad electrically connected to the first via through a first delay line, a fourth resistor pad located in proximity to the third resistor pad and capable of being electrically connected to a first component, a fifth resistor pad located in proximity to the second resistor pad and a sixth resistor pad electrically connected through a second delay line to the fifth resistor pad, where the sixth resistor pad is located in proximity to the fourth resistor pad, and a second set of resistor pads on a second side of the module, including a seventh resistor pad electrically connected to the first via and an eighth resistor pad electrically connected to the second via, where the seventh resistor pad is located in proximity to the eighth resistor pad.

In yet another aspect, the present invention provides a stacked resistor pad combination comprising a first set of resistor pads on a first side of a module, including a first resistor pad electrically connected to a first via, a second resistor pad electrically connected to a second via, where the second resistor pad is located in proximity to the first resistor pad, a third resistor pad electrically connected to the first via through a first delay line, a fourth resistor pad located in proximity to the third resistor pad and capable of being electrically connected to a first component, a fifth resistor pad located in proximity to the first resistor pad and a sixth resistor pad electrically connected through a second delay line to the fifth resistor pad, where the sixth resistor pad is located in proximity to the fourth resistor pad, and a second set of resistor pads on a second side of the module, including a seventh resistor pad electrically connected to the first via and an eighth resistor pad electrically connected to the second via, where the seventh resistor pad is located in proximity to the eighth resistor pad.

In still another aspect, the present invention includes a method of providing variable delays to a signal through a stacked resistor pad combination comprising a first set of resistor pads on a first side of a module, including a first resistor pad electrically connected to a first via and a second resistor pad electrically connected to a second via, where the second resistor pad is located in proximity to the first resistor pad, and a second set of resistor pads on a second side of the module, including a third resistor pad electrically connected to the first via and a fourth resistor pad electrically connected to the second via, where the fourth resistor pad is located in proximity to the third resistor pad, where the method includes the step of forming an electrical connection between the first and second resistor pads.

### BRIEF DESCRIPTION OF THE DRAWINGS

FIG. 1a is a block diagram of prior art resistor pad combination;

FIGS. 1b-1e are block diagrams of various delays using the prior art resistor pad combination of FIG. 1a;

FIGS. 2a-2c are block diagrams of a stacked resistor pad combination;

FIGS. 3a-3n are block diagrams of various delays using the stacked resistor pad combination of FIGS. 2a-2c;

FIG. 4a is a block diagram of an alternate embodiment of a stacked resistor pad combination;

FIGS. 4b-4c are block diagrams of various delays using the stacked resistor pad combination of FIG. 4a;

FIG. 4d is a block diagram of another alternate embodiment of a stacked resistor pad combination;

FIGS. 4e-4f are block diagrams of various delays using the stacked resistor pad combination of FIG. 4d;

FIG. 5a is a block diagram of yet another alternate embodiment of a stacked resistor pad combination; and

FIGS. 5b-5d are block diagrams of various delays using the stacked resistor pad combination of FIG. 5a.

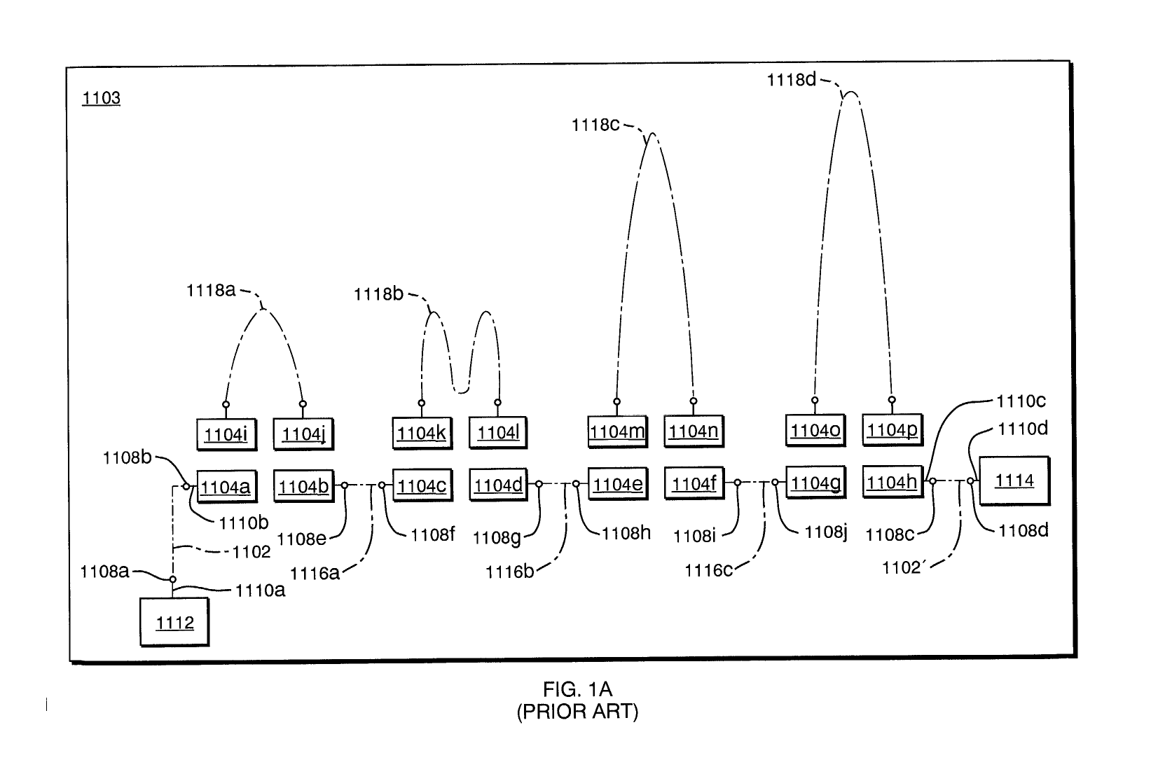

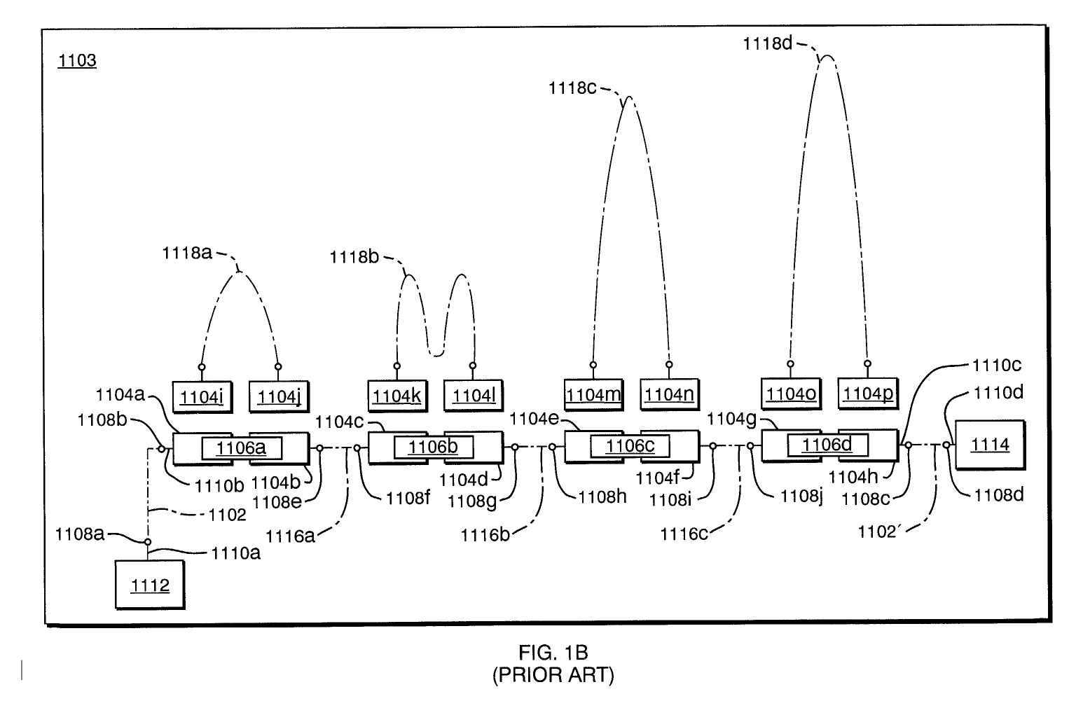

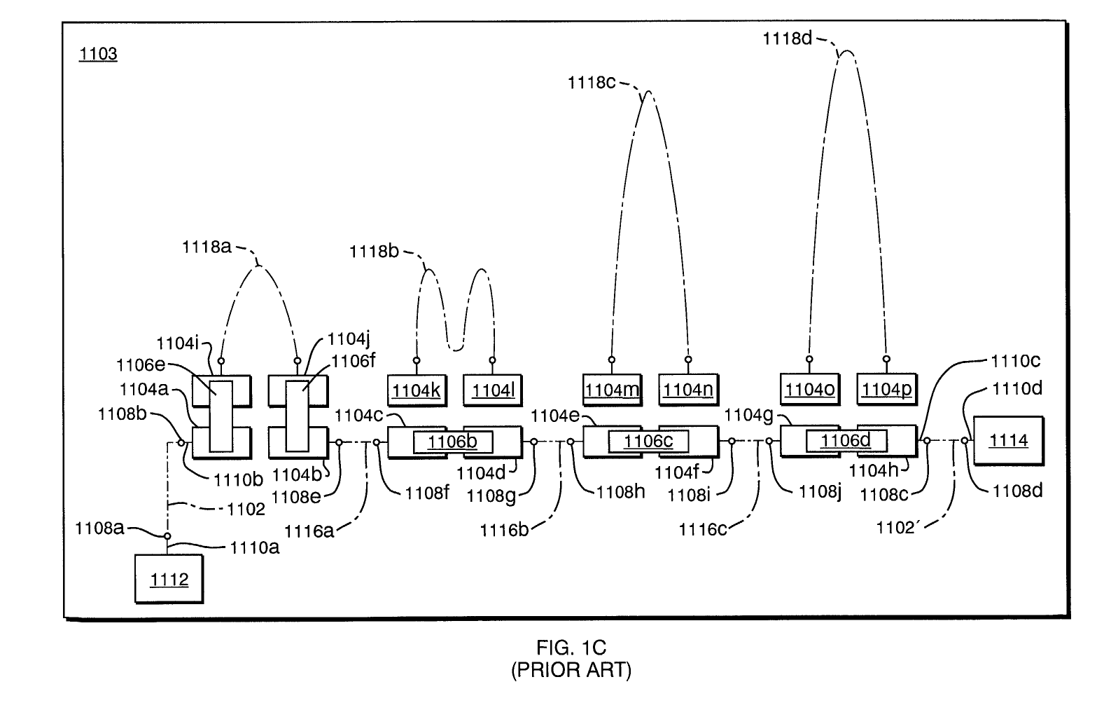

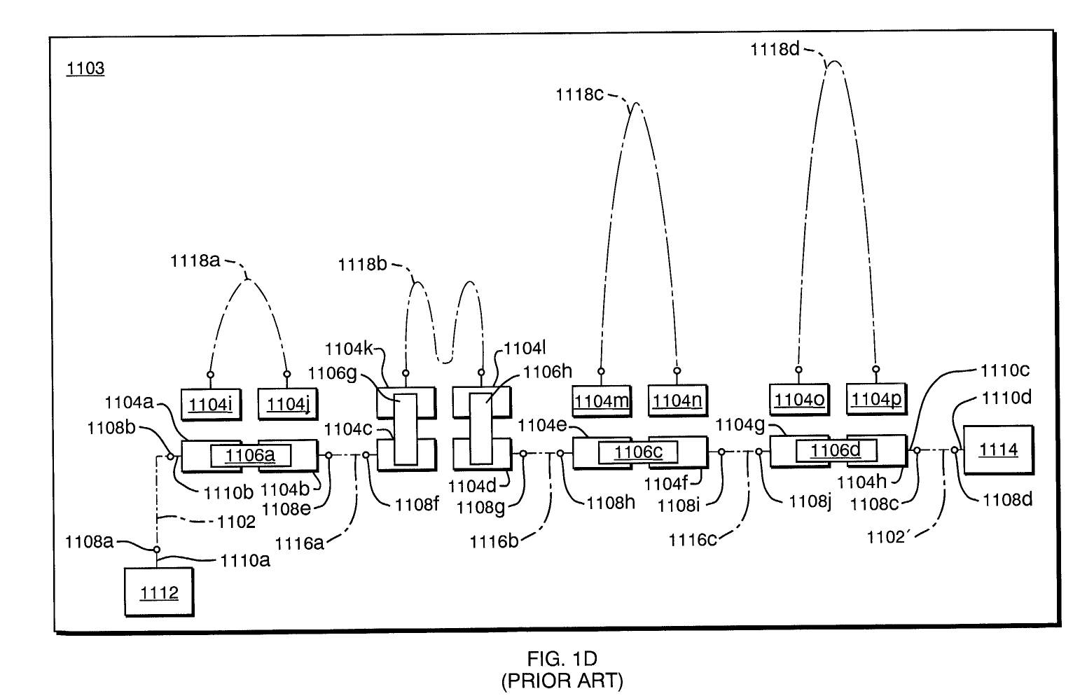

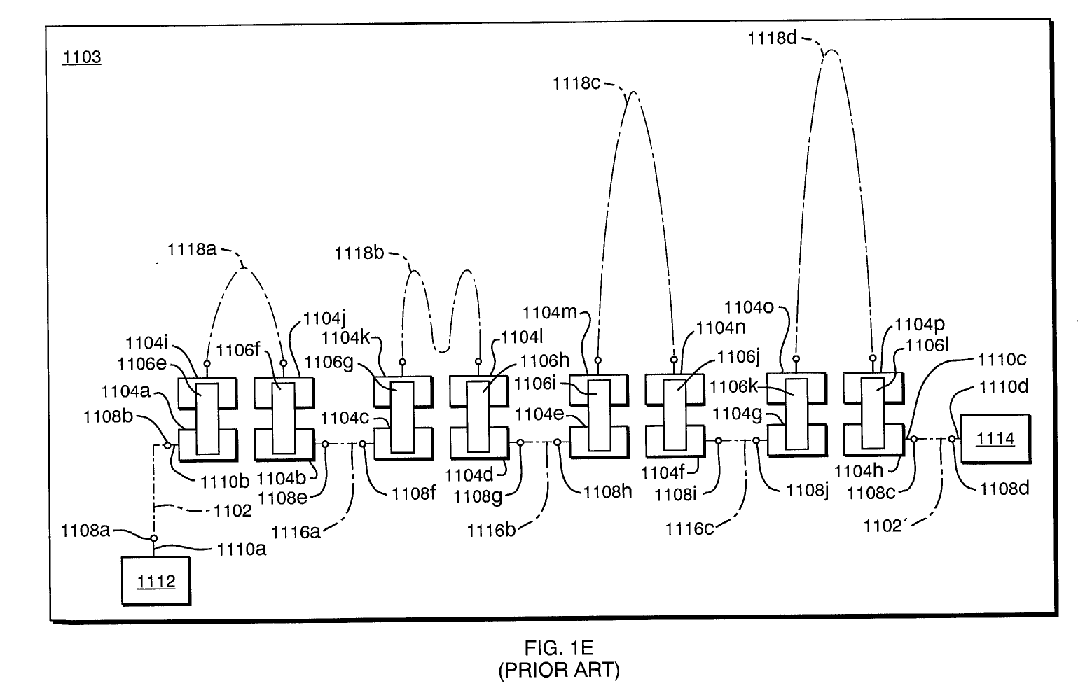

### DETAILED DESCRIPTION

During the design of a new network device, the designers may plan to use components that are also in the process of being designed, and in such instances, the exact timing of data, clock and other signals may not be known. As a result, once the component is complete, the designer examines the printed circuit board (i.e., board, module, card) on which the component is mounted and may need to shift the timing of one or more signals on the module to insure that each of the components on the module function properly. For example, a clock signal on the module may need to be time shifted with respect to the data signals to insure data integrity, for instance, by centering the rising edge of the clock in the middle of the data pulse to meet set up and hold times.

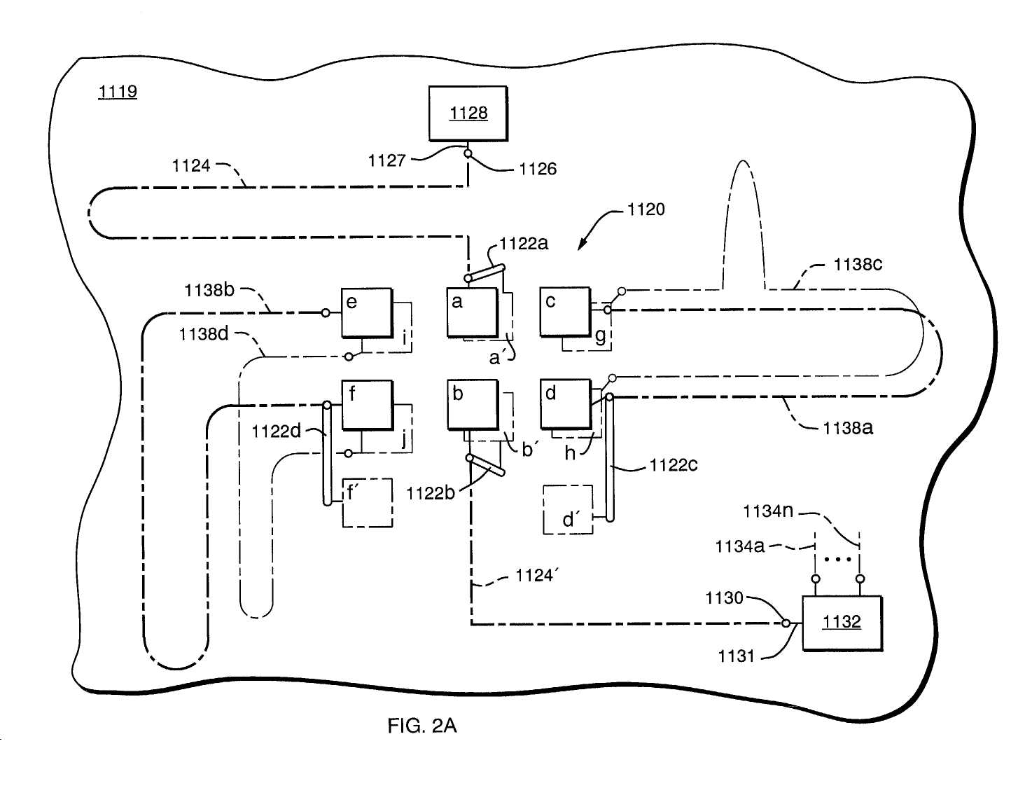

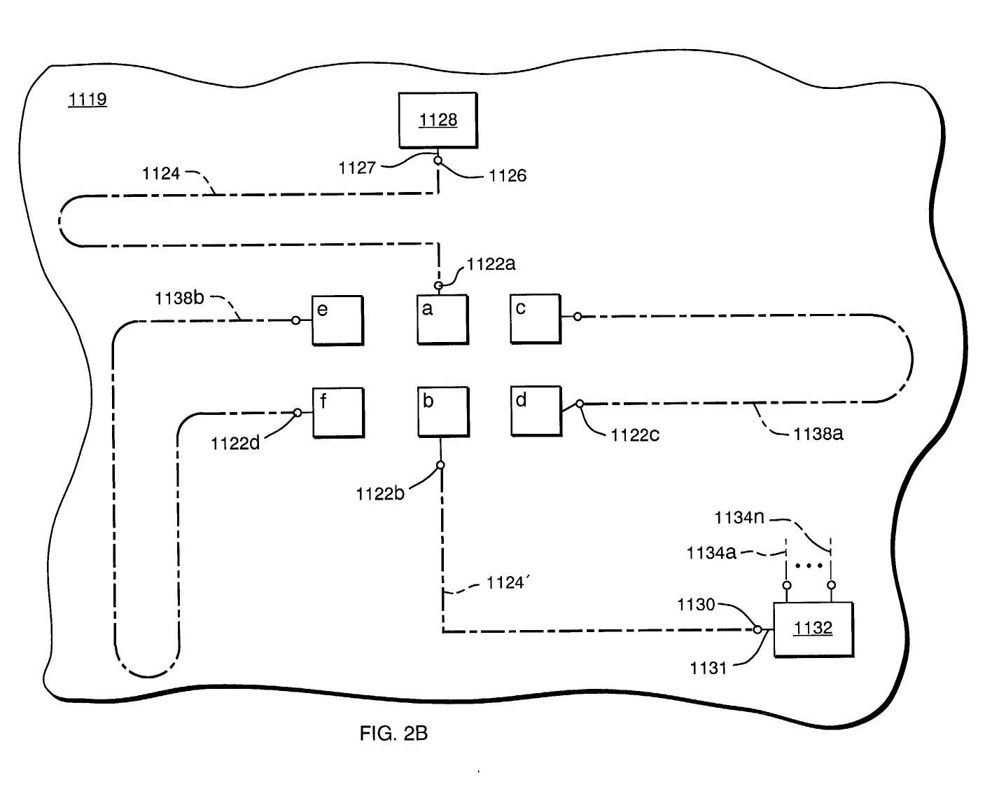

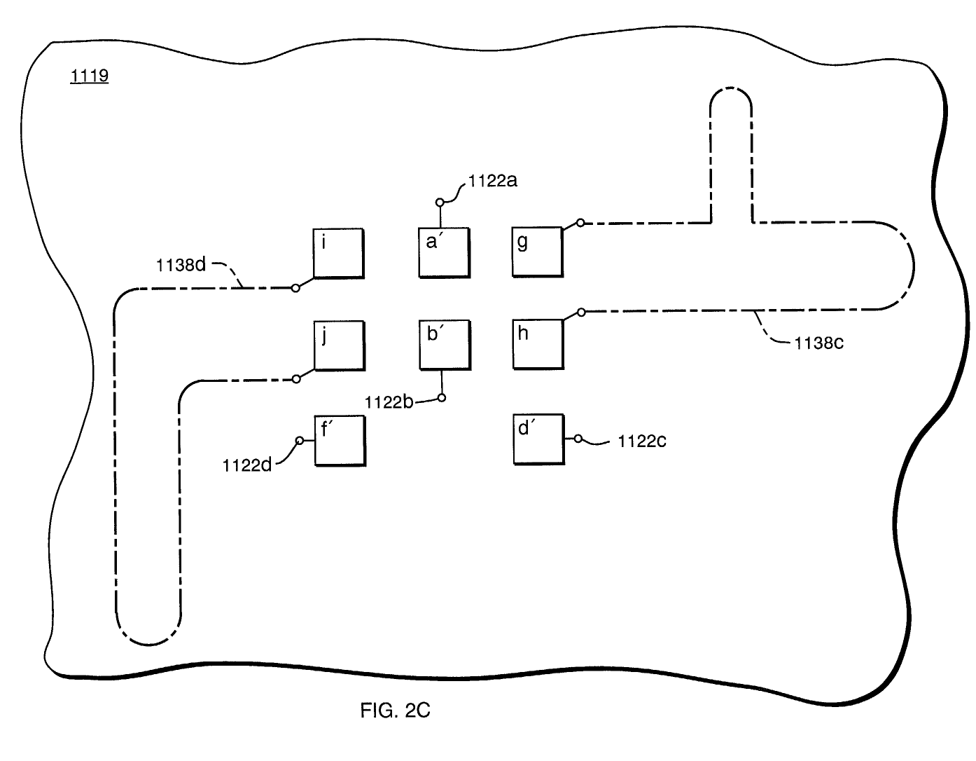

In one embodiment, a signal may be shifted in time by adding delay etch to the signal etch on a module 1119 (FIG. 2a) through a combination of stacked resistor pads (e.g., 1120). Compared to current resistor pad delay configurations, stacked resistor pads provide a larger number of delay variations using a smaller number of resistors, resistor pads and vias and a smaller amount of etch (internal and surface). At high speeds, for example, greater than 100 MHz, vias may add significant capacitance to signals. Thus, the stacked resistor pads minimize signal deterioration while consuming a smaller amount of module space.

Referring to FIGS. 2a-2c, in one embodiment, the stacked resistor pads include resistor pads a, b, c, d, e and f on one side (e.g., top) of the module and resistor pads, a′, b′, d′, f, g, h, i and j on the other side (e.g., bottom) of the module. As shown, resistor pad a is directly above pad a′, pad b is directly above pad b′, pad c is directly above pad g, pad d is directly above pad h, pad e is directly above pad i, and pad f is directly above pad j. Pads d′ and f′ are offset and not directly under the resistor pads on the top of the module. In addition, resistor pads a and a′ are electrically connected through a via 1122a, pads b and b′ are electrically connected through a via 1122b, pads d and d′ are electrically connected through a via 1122c and pads f and f′ are electrically connected through a via 1122d.

It should be understood that stacking resistor pads on one side of the module directly over resistor pads on the other side of the module is preferred to save as much module surface space as possible. Alternatively, the pads on one side of the module may be offset with respect to the pads on the other side of the module. In addition, other resistor pad stacking arrangements are possible, and other pad stacking configurations are discussed below. In the figures, dashed signal lines and delay etches indicate that the signals may be routed on internal module layers or on a surface module layer. Preferably, they are routed on internal module layers such that they are less susceptible to noise. Also in the figures, resistors and resistor pads on the bottom of the module (i.e., a′, b′, d′, f′, g-j) are shown using dashed lines. Jumpers may be used instead of resistors. However, resistors are preferred since at high-speeds jumpers are less reliable than resistors.

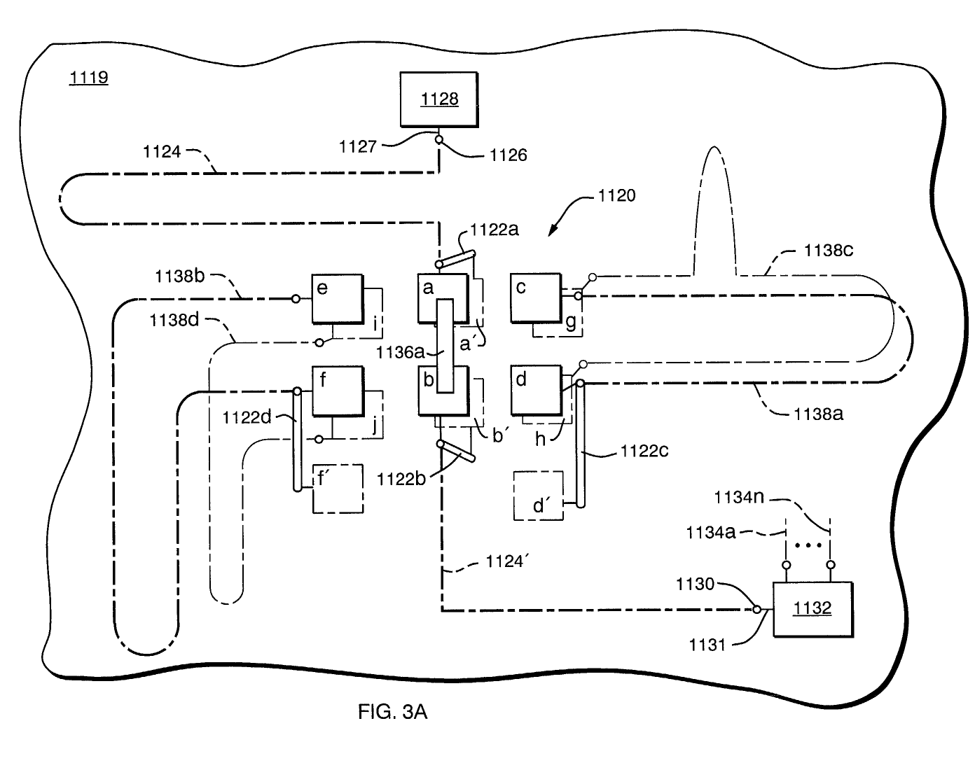

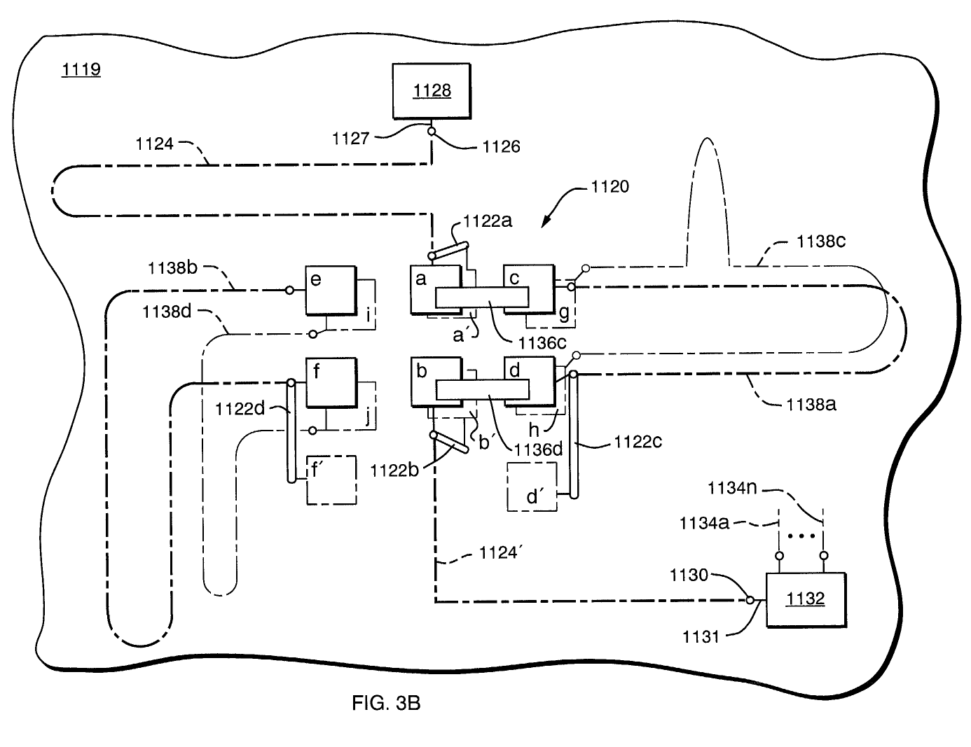

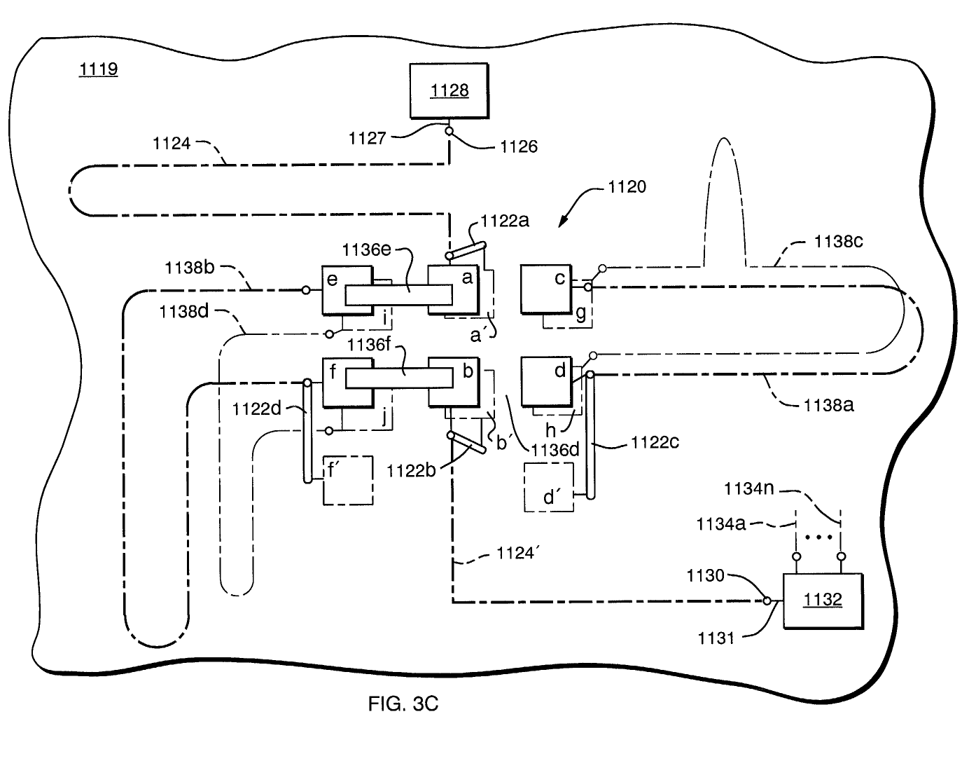

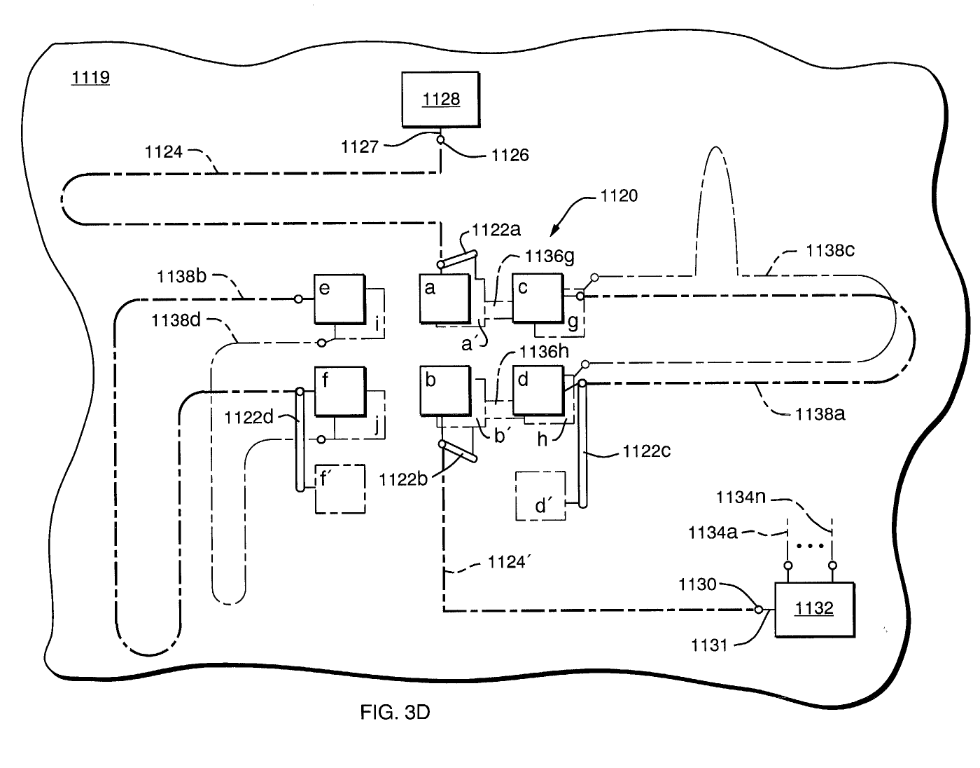

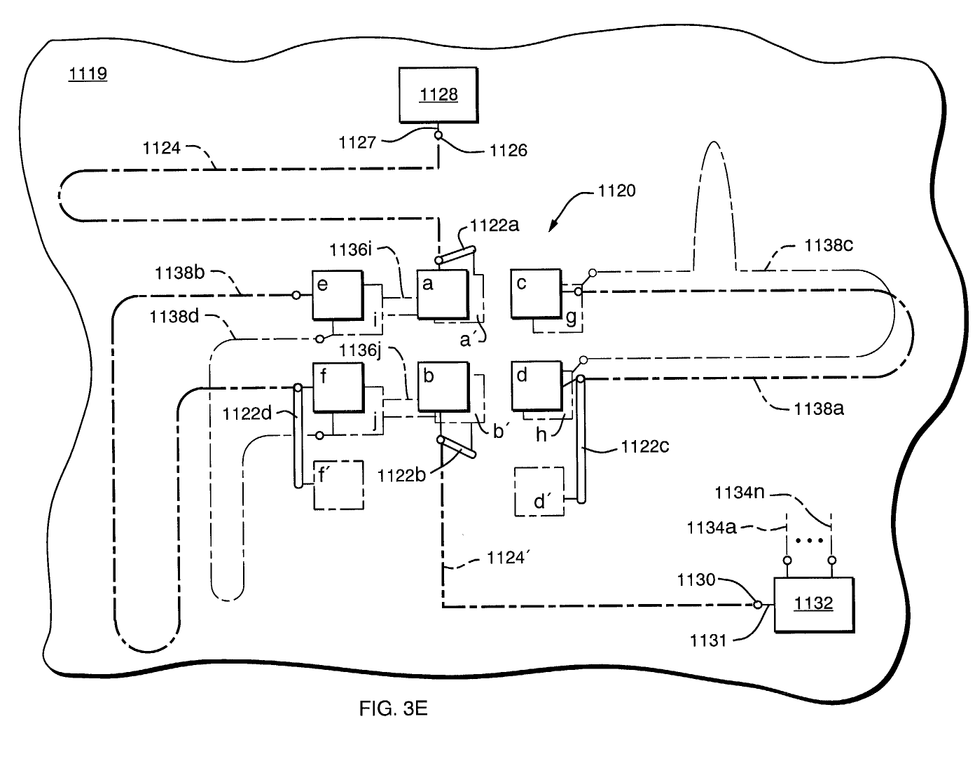

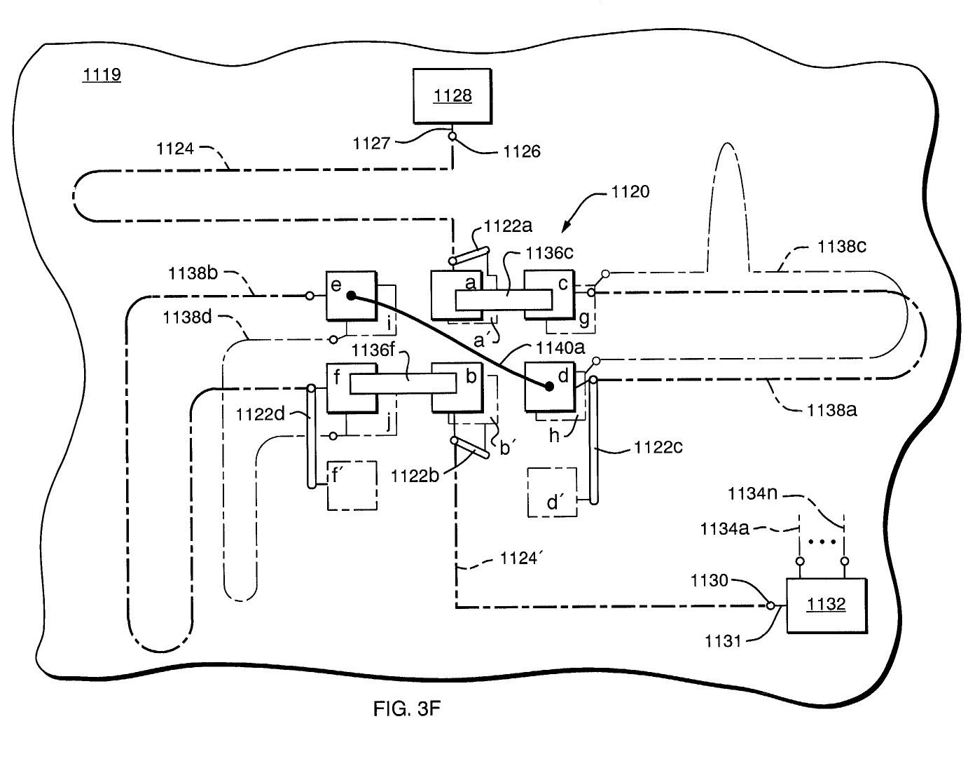

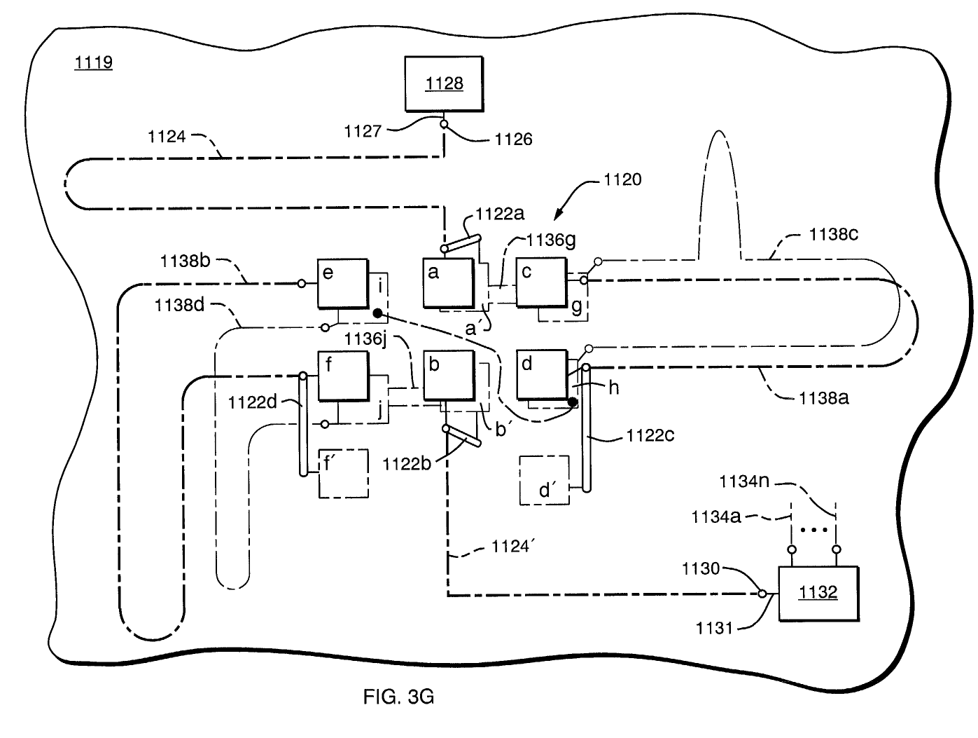

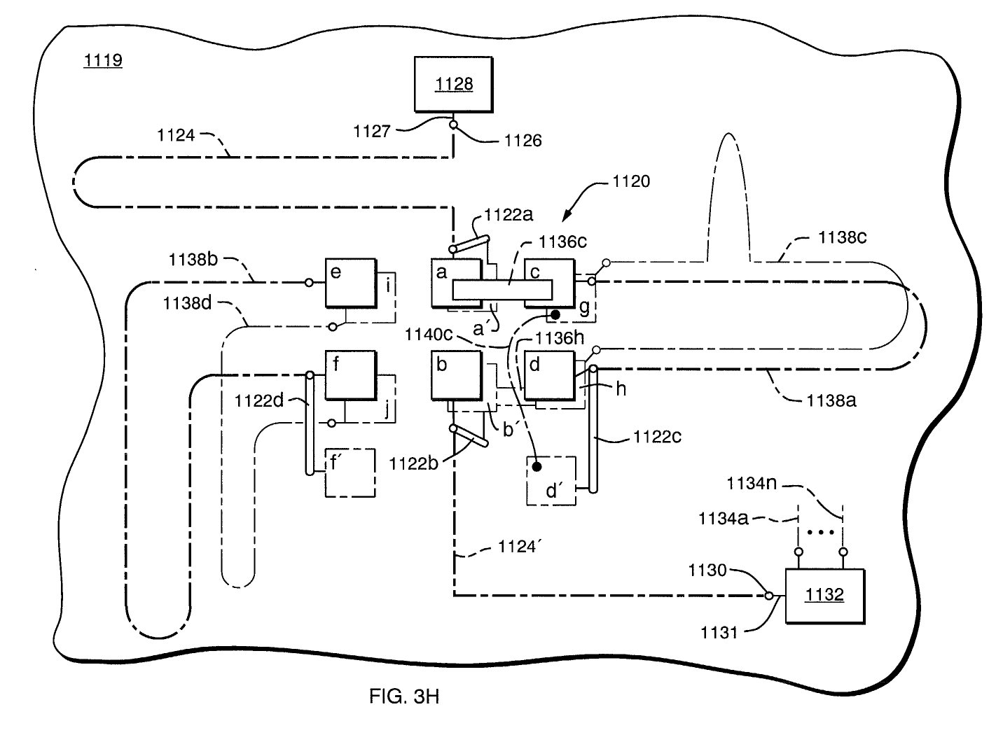

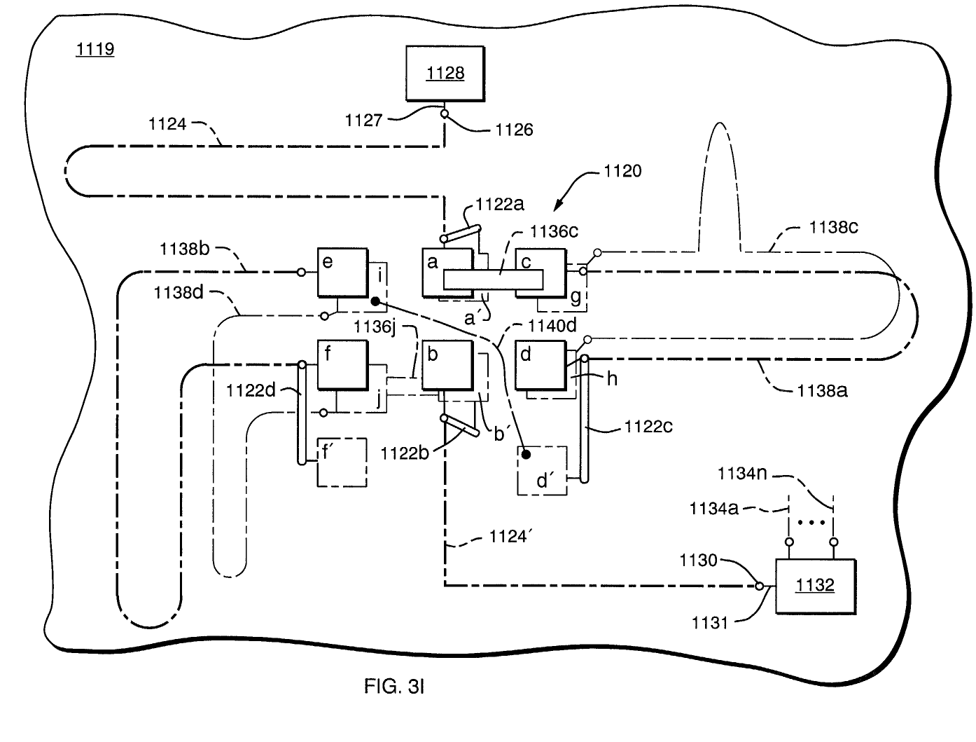

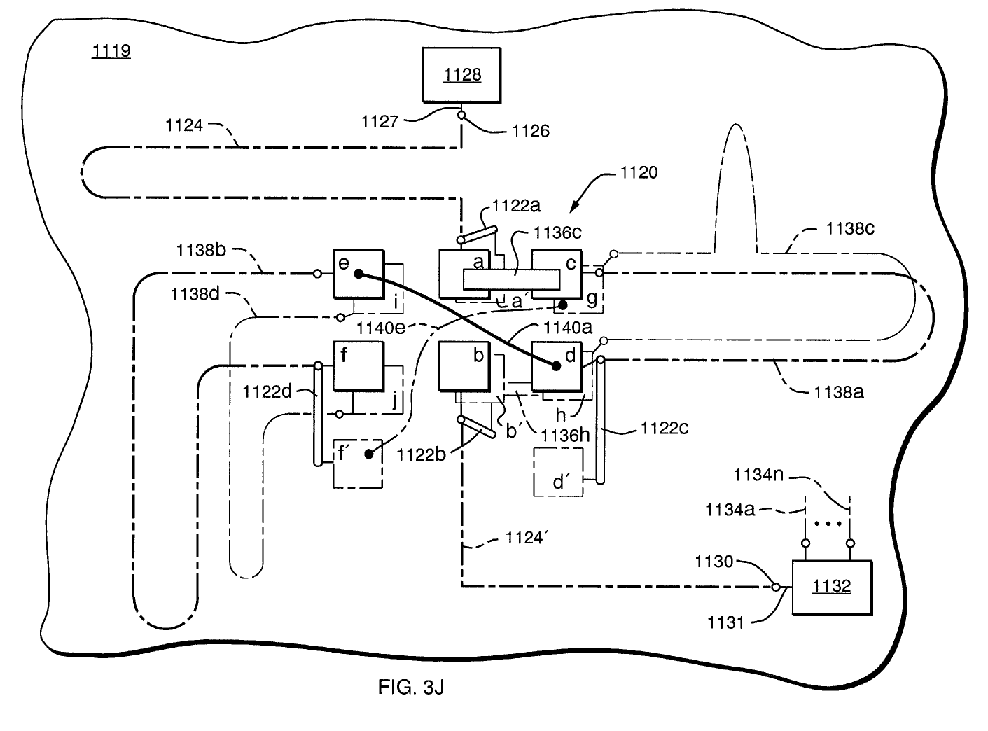

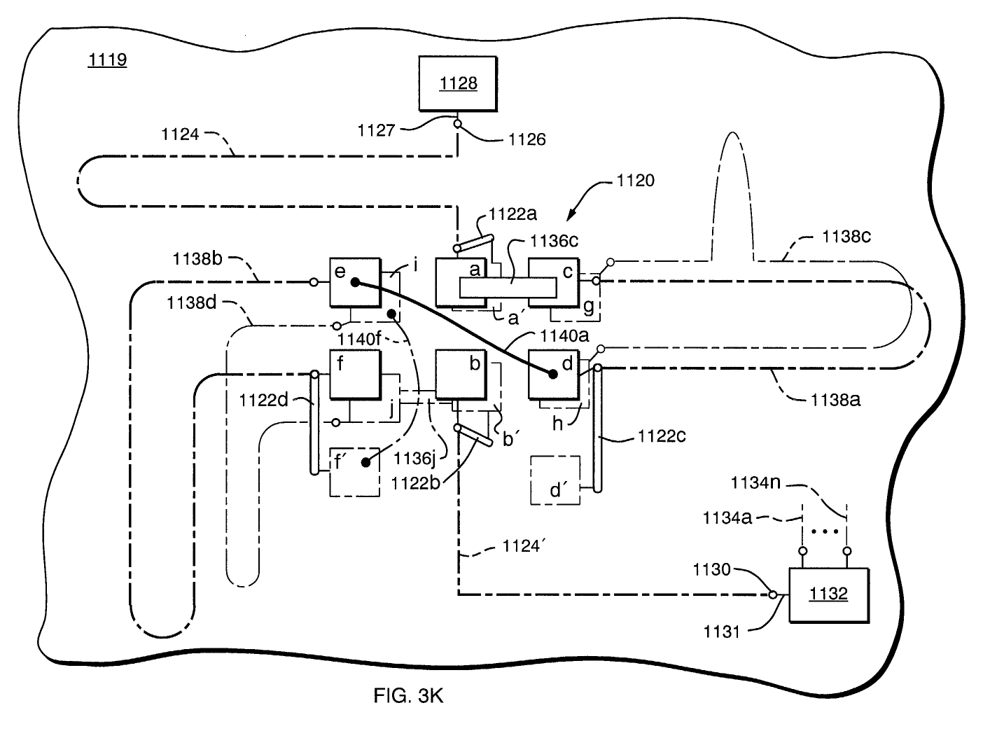

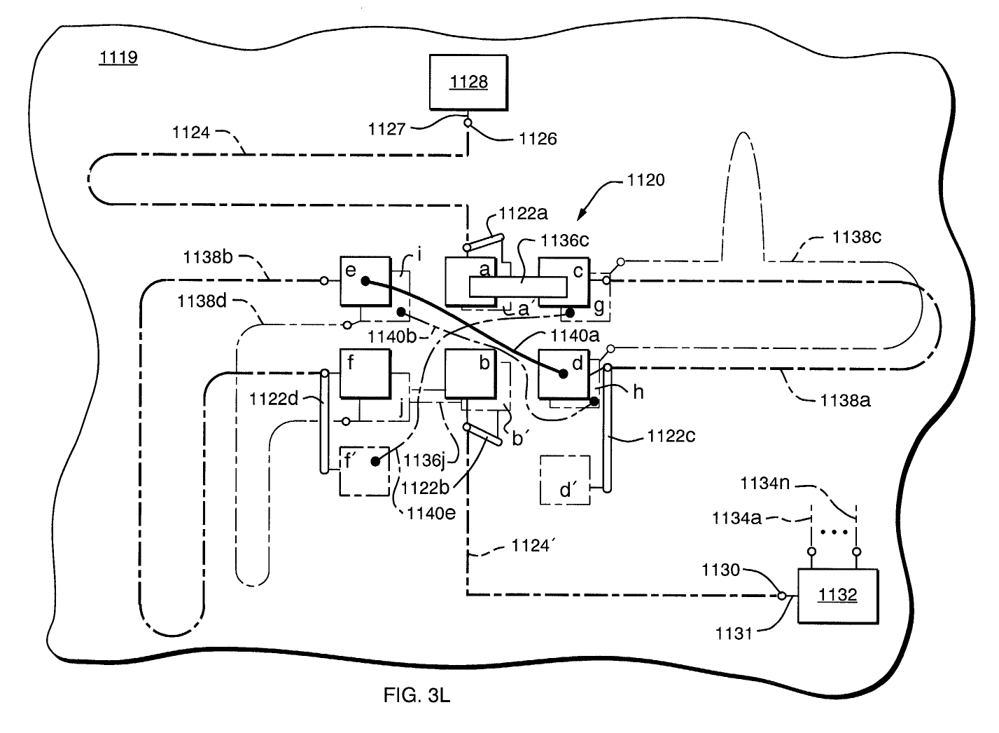

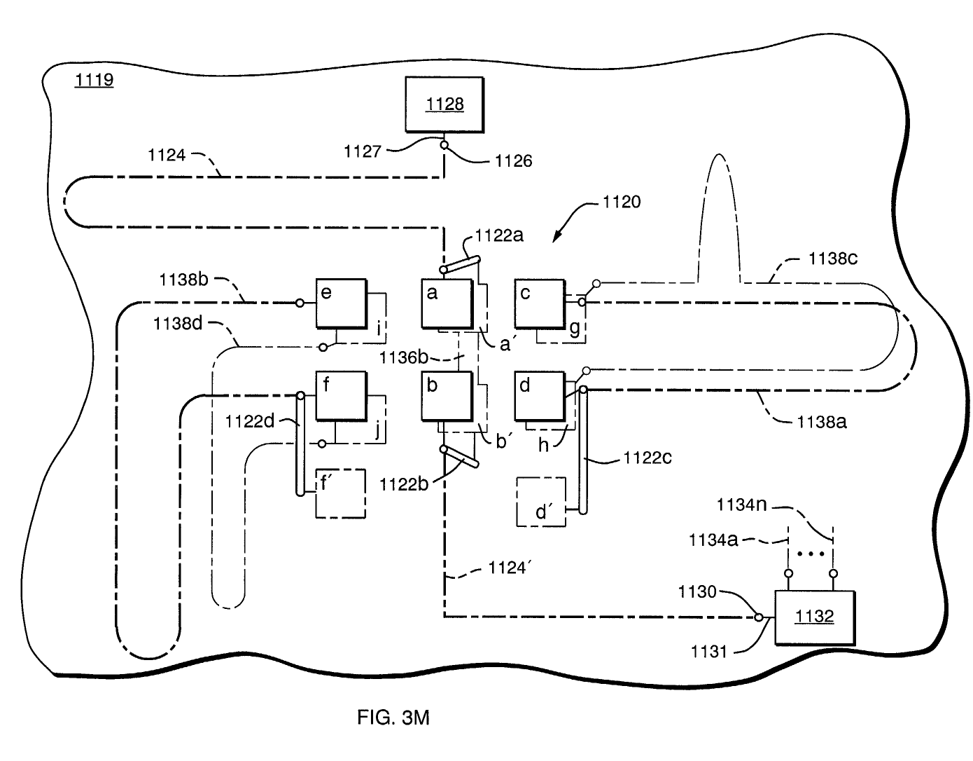

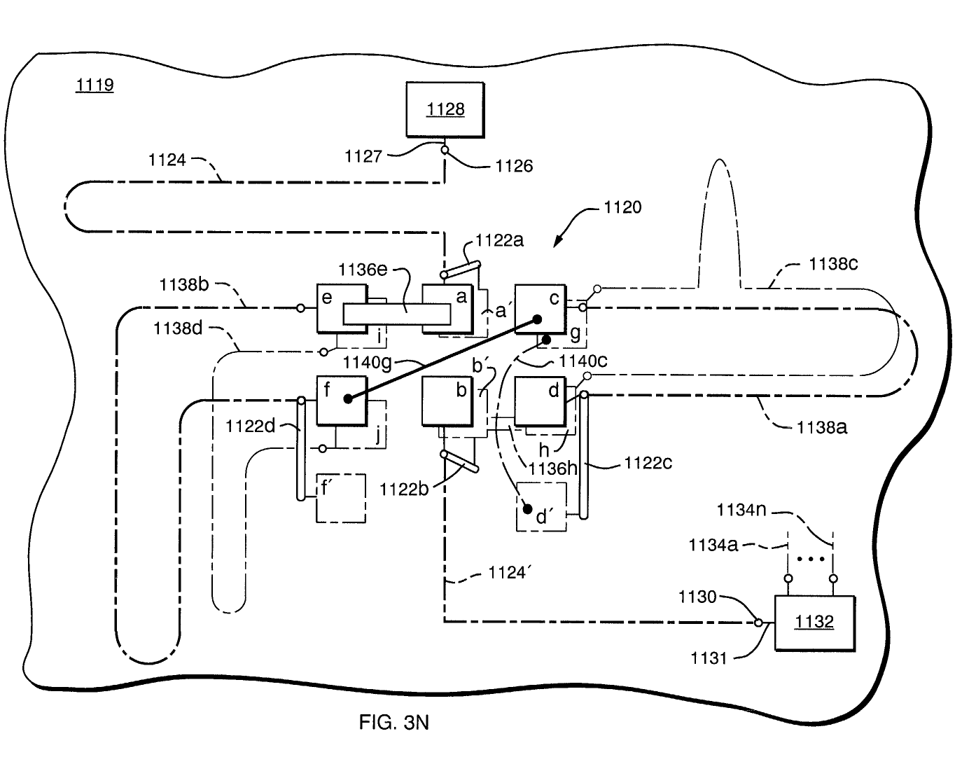

Pads a and a′, through via 1122a, are also connected to a signal etch 1124 which is connected to a via 1126 and to an output 1127 of an integrated circuit component 1128. Similarly, pads b and b′, through via 1122b, are also connected to a signal etch 1124′ which is connected to a via 1130 and to an input 1131 of an integrated circuit component 1132. Signal 1124, 1124′ may be a clock signal, and component 1132 may also receive data signals 1134a-1134n. To shift the timing of signal 1124, 1124′, various resistors may be added to the resistor pads a-j, a′, b′, d′ and f′. For example, the minimum delay through the resistor pads is accomplished by adding a resistor 1136a (FIG. 3a) across resistor pads a and b. Thus, only one resistor, two resistor pads and two vias are necessary for the minimum delay.

Additional delays may be added to signal 1124, 1124′ by connecting resistors across the other resistor pads to access additional delay lines. For example, pads c and d may be electrically connected together through a delay etch 1138a (e.g., 250 ps), pads e and f may be electrically connected together through a delay etch 1138b (e.g., 500 ps), pads g and h may be electrically connected together through a delay etch 1138c (e.g., 1000 ps) and pads i and j may be electrically connected together through a delay etch 1138d (e.g., 2000 ps). It should be understood that instead of having each delay etch provide a different delay, each delay etch may provide the same delay. It is preferred to have each delay etch be different, however, to provide a greater number of delay combinations.

To add delay etch 1138a to signal 1124, 1124′, resistor 1136c (FIG. 3b) may be connected across resistor pads a and c and resistor 1136d may be connected across resistor pads b and d. To add delay etch 1138b to signal 1124, 1124′, resistor 1136e (FIG. 3c) may be connected across resistor pads a and e and resistor 1136f may be connected across resistor pads b and f. To add delay etch 1138c to signal 1124, 1124′, resistor 1136g (FIG. 3d) may be connected across resistor pads a′ and g and resistor 1136h may be connected across resistor pads b′ and h. To add delay etch 1138d to signal 1124, 1124′, resistor 1136i (FIG. 3e) may be connected across resistor pads a′ and i and resistor 1136j may be connected across resistor pads b′ and j.

In addition, various combinations of the delay etches may be added to signal 1124, 1124′. Referring to FIG. 3f, for example, delay etches 1138a and 1138b may both be added to signal 1124, 1124′ by connecting resistor 1136c between pads a and c, connecting a wire 1140a between pads d and e and connecting resistor 1136f between pads b and f. Since the resistor pads are located closely together, wire 1140a may be very short in length, for example, 0.25 inches. Referring to FIG. 3g, similarly, delay etches 1138c and 1138d may be added to signal 1124, 1124′ by connecting resistor 1136g across pads a′ and g, a wire 1140b (dashed line indicating across bottom of module) from pad h to pad i and resistor 1136j across pads b′ and j. Referring to FIG. 3h, delay etches 1138a and 1138c may be added to signal 1124, 1124′ by connecting resistor 1136c across pads a and c, a wire 1140c from pad d′ to pad g and resistor 1136h across pads b′ and h. Referring to FIG. 3i, delay etches 1138a and 1138d maybe added to signal 1124, 1124′ by connecting resistor 1136c across pads a and c, a wire 1140d from pad d′ to pad i and resistor 1136j across pads b′ and j.

Referring to FIG. 3j, delay etches 1138a, 1138b and 1138c may be added to signal 1124, 1124′ by connecting resistor 1136c across pads a and c, a wire 1140a from pad d to pad e, a wire 1140e from pad f′ to pad g and resistor 1136h across pads b′ and h. Referring to FIG. 3k, delay etches 1138a, 1138b and 1138d may be added to signal 1124, 1124′ by connecting resistor 1136c across pads a and c, a wire 1140a from pad d to pad e, a wire 1140f from pad f′ to pad i and resistor 1136j across pads b′ and j. Many other combinations of delay etches are possible, including the maximum delay of adding delay etches 1138a, 1138b, 1138c and 1138d. Referring to FIG. 3L, one possible way to attain the maximum delay is to connect resistor 1136c across pads a and c, a wire 1140a from pad d to pad e, a wire 1140e from pad f′ to pad g, a wire 1140b from pad h to pad i and resistor 1136j across pads b′ and j.

Since four delay etches (1138a-1138d) are provided, fifteen possible delay combinations are possible, including the minimum delay. However, the resistor pad stacking configuration allows each possible delay combination to be gained in multiple, different ways. For example, as described above with reference to FIG. 3a, the minimum delay is achieved by connecting resistor 1136a between resistor pads a and b. However, the minimum delay may also be achieved by connecting a resistor 1136b (FIG. 3m) across resistor pads a′ and b′. As another example, as described above with reference to FIG. 3j, delay etches 1138a, 1138b and 1138c may be added to signal 1124, 1124′ by connecting resistor 1136c across pads a and c, a wire 1140a from pad d to pad e, a wire 1140e from pad f′ to pad g and resistor 1136h across pads b′ and h. However, these same delay etches may be added to signal 1124, 1124′ by connecting resistor 1136e (FIG. 3n) across pads a and e, a wire 1140g from pad f to pad c, a wire 1140c from pad d′ to pad g and a resistor 1136h across pads h and b′. Providing multiple ways of achieving the possible delay combinations allows for flexibility. For instance, if a pad or via in the stacked resistor pad combination is damaged, the designer may provide the desired delay combination using other pads and/or vias in the stacked resistor pad combination.

Currently available resistor pad combinations that provide four delay etches require sixteen resistor pads as opposed to the fourteen resistor pads required by stacked resistor pads 1120. In addition, the minimum delay in the currently available resistor pad combinations that provide four delay etches require four resistors as opposed to the one resistor required by the stacked resistor pads 1120. Similarly, the currently available resistor pad combinations that provide four delay etches require eight resistors for the maximum delay as opposed to the two resistors and three wires required by the stacked resistor pads 1120. If all delay etches and signals are routed on internal layers, then the currently available resistor pad combinations that provide four delay etches require sixteen vias as opposed to the ten vias required by the stacked resistor pads 1120. Reducing the number of resistors/wires and vias reduces the capacitance added to the signal, which reduces potential signal degradation, especially at high-speeds. In addition, lowering the number of resistors/wires lowers the potential for manufacturing defects and errors due to missing or broken parts. Importantly, the stacked resistor pads 1120 consume approximately half the surface space required by the currently available resistor pad combinations that provide four delay etches.

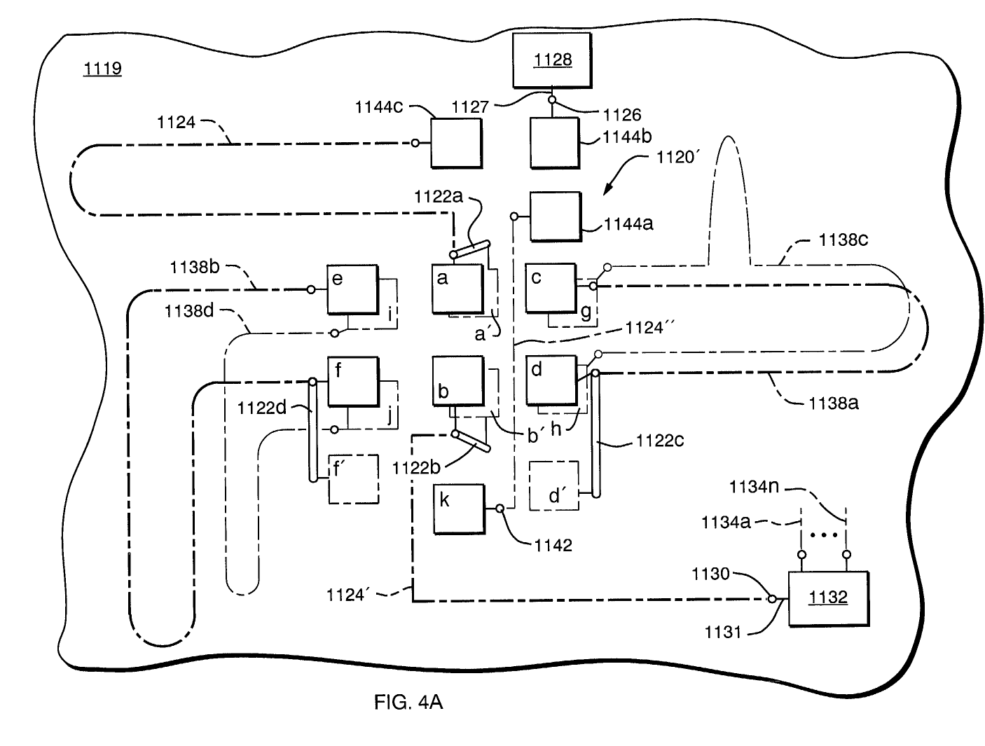

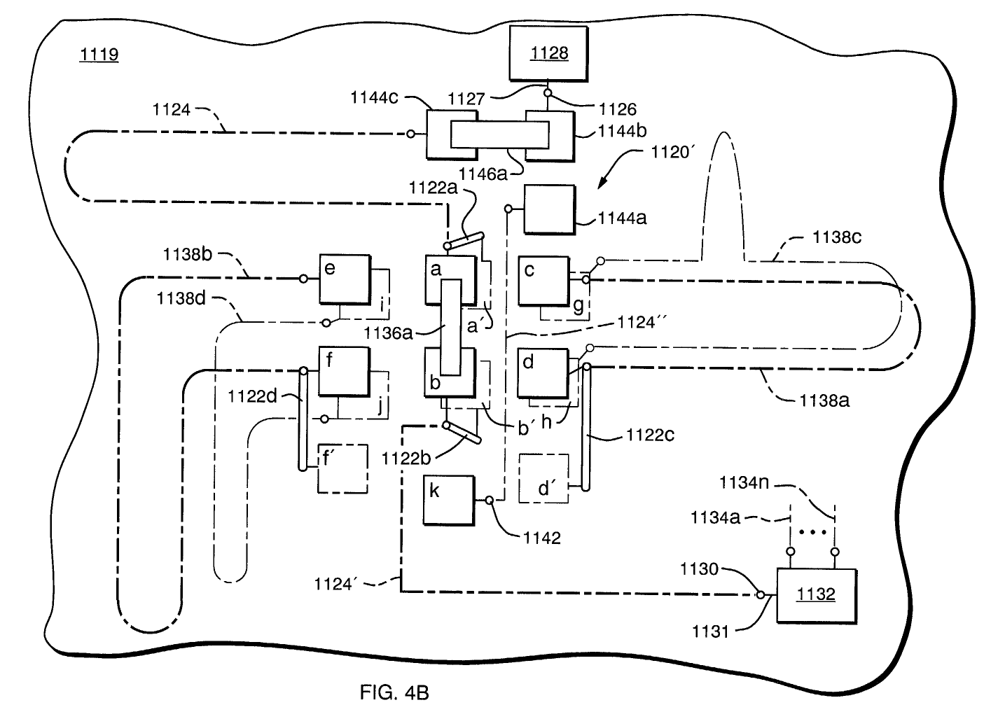

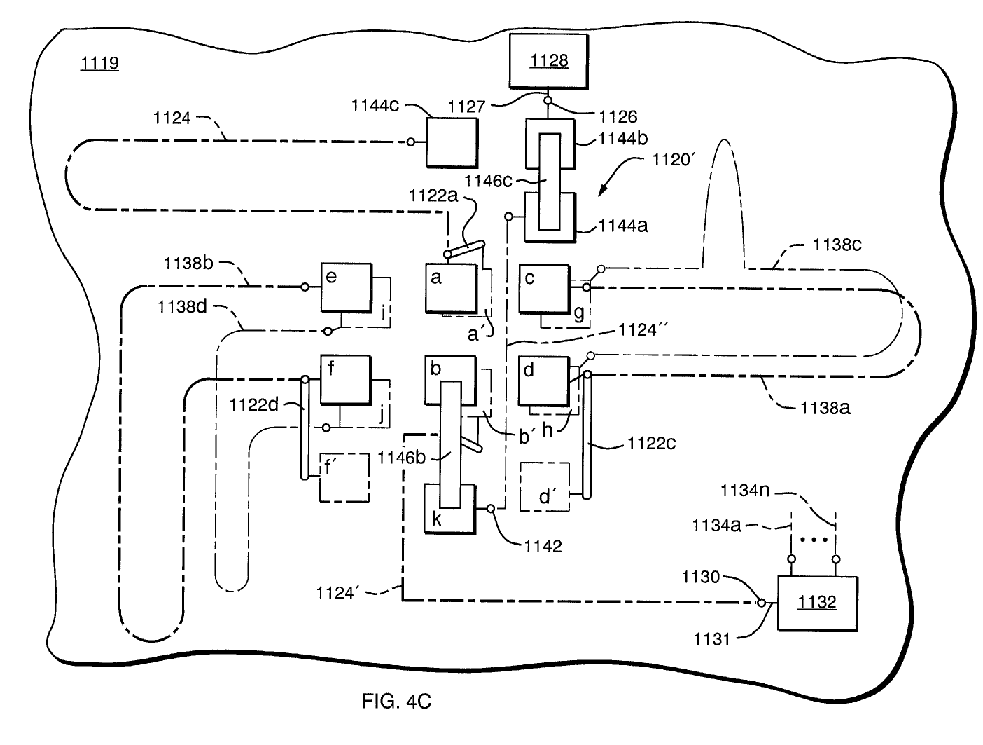

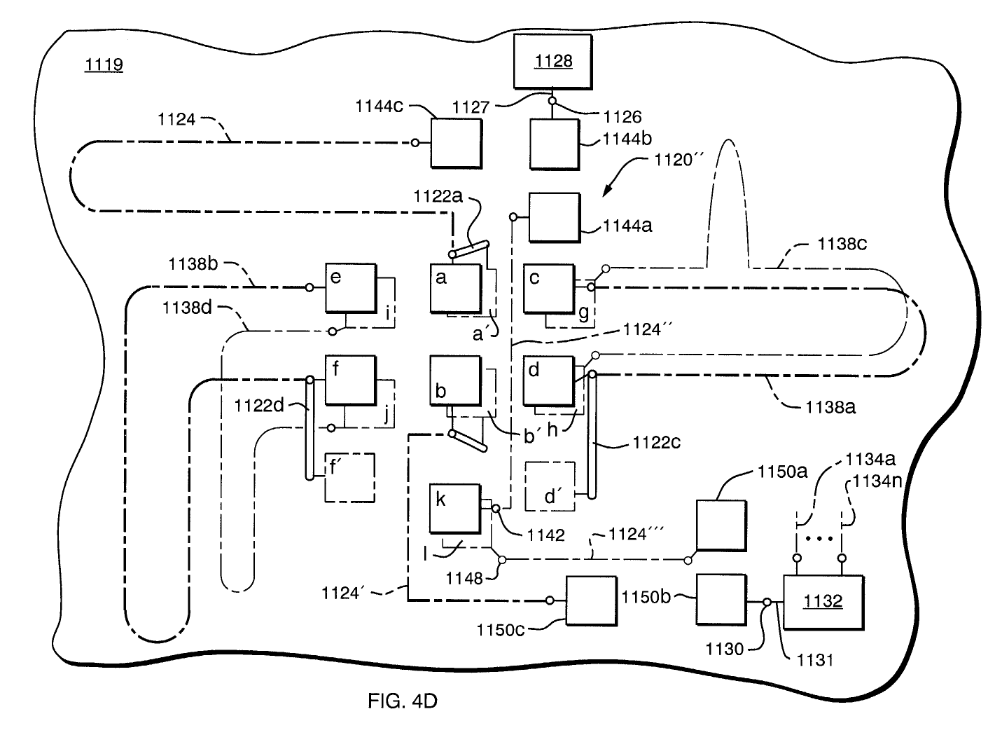

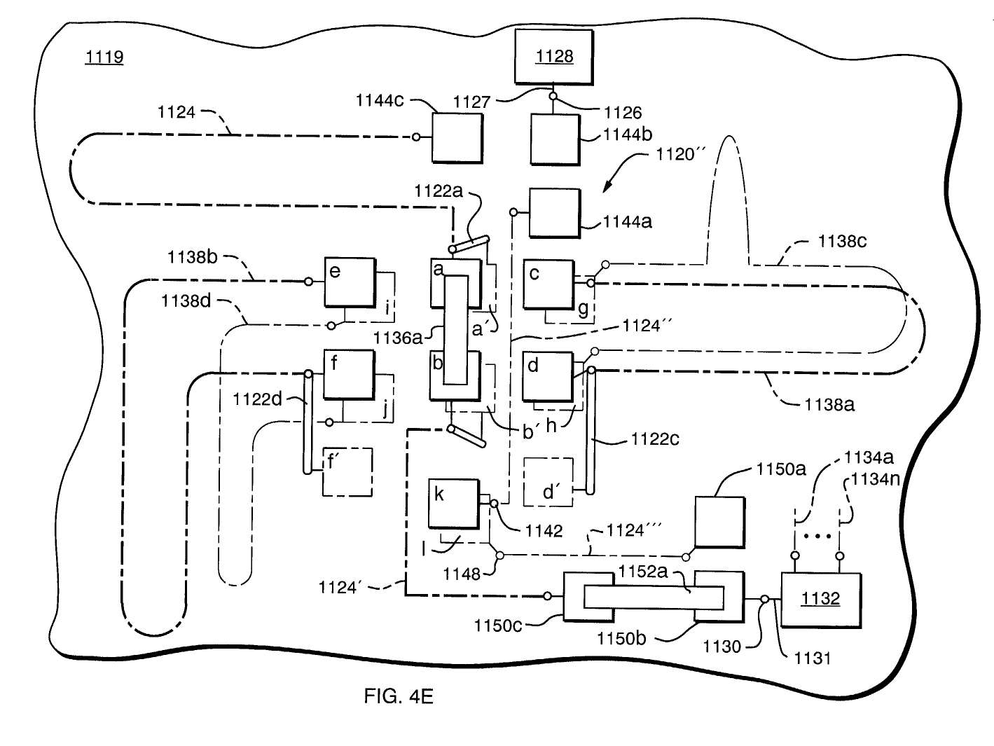

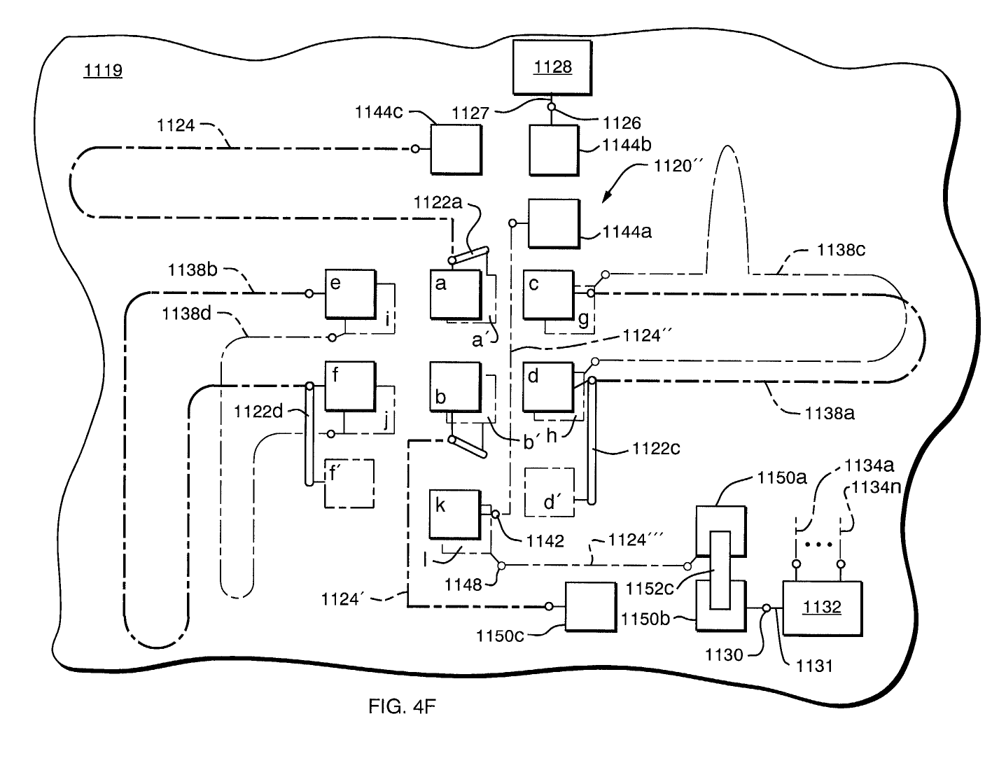

As described above, pad a within stacked resistor pads 1120 is electrically connected to output 1127 of integrated circuit component 1128 and pad b is electrically connected to input 1131 of component 1132. When a resistor is connected across resistor pads a and b, the minimum delay is added to signal 1124, 1124′. Resistor pads may also be used to provide various delays directly to the components. For example, referring to FIG. 4a, an additional pad k may be added to form an alternative stack of resistor pads 1120′. Pads a-j, a′, b′, d′ and f′ function as described above with respect to stacked resistor pads 1120. Pad k is electrically connected to a signal 1124″ through a via 1142. Either signal 1124 or signal 1124″ may be connected to output 1127 of component 1128 through resistor pads 1144a-1144c.

Signal 1124″ is shorter in length than signal 1124 and, thus, provides a shorter amount of delay. This may be referred to as a negative delay since 1124″ provides less delay than 1124. When the module is designed, signal 1124, 1124′ with the minimal delay (see FIG. 3a) is set to match the length of other relevant signals. For example, signal 1124, 1124′ may be a clock signal and a designer may match the length of signal 1124, 1124′ with the minimal delay to the length of data signals (e.g., 1134a-1134n, FIG. 2b). If after component 1128 is received the designer determines he needs less than the minimal delay, he may use signal 1124″, 1124′ instead of signal 1124, 1124′ since signal 1124″, 1124′ is shorter than signal 1124, 1124′.

Pad k and pads 1144a-1144c, therefore, permits the designer to choose a different minimum delay. For example, a designer may connect resistor 1136a (FIG. 4b) across resistor pads a and b and a resistor 1146a across resistor pads 1144c and 1144b to use the delay provided by signal 1124. Instead, the designer may connect a resistor 1146b (FIG. 4c) across resistor pads b and k and a resistor 1146c across resistor pads 1144a and 1144b to use the delay provided by signal 1124″.

Similarly, a pad L (FIG. 4d) may be added to stacked resistor pad combination 1120″ on the bottom of the module and connected to a signal 1124′″ through a via 1148. Either signal 1124′ or signal 1124′″ maybe connected to input 1131 of component 1132 through resistor pads 1150a-1150c. Again, signal 1124′″ is shorter in length than signal 1124′ and, thus, provides a shorter amount of delay (i.e., negative delay). For example, a designer may connect resistor 1136a (FIG. 4e) across resistor pads a and b and a resistor 1152a across resistor pads 1150c and 1150b to use the delay provided by signal 1124′. Instead, the designer may connect a resistor 1152b (FIG. 4f) across resistor pads b′ and L and a resistor 1152c across resistor pads 1150a and 1150b to use the delay provided by signal 1124′″. As a result, various minimum delays (e.g., 1124-1124′, 1124-1124′″ and/or 1124″-1124′, 1124″-1124′″) may also be created using stacked resistor pads. For further flexibility in delay combinations, any of the available minimal delays may then be added to the various delay etches (e.g., 1138a-1138d) provided by the stacked resistor pad combination.

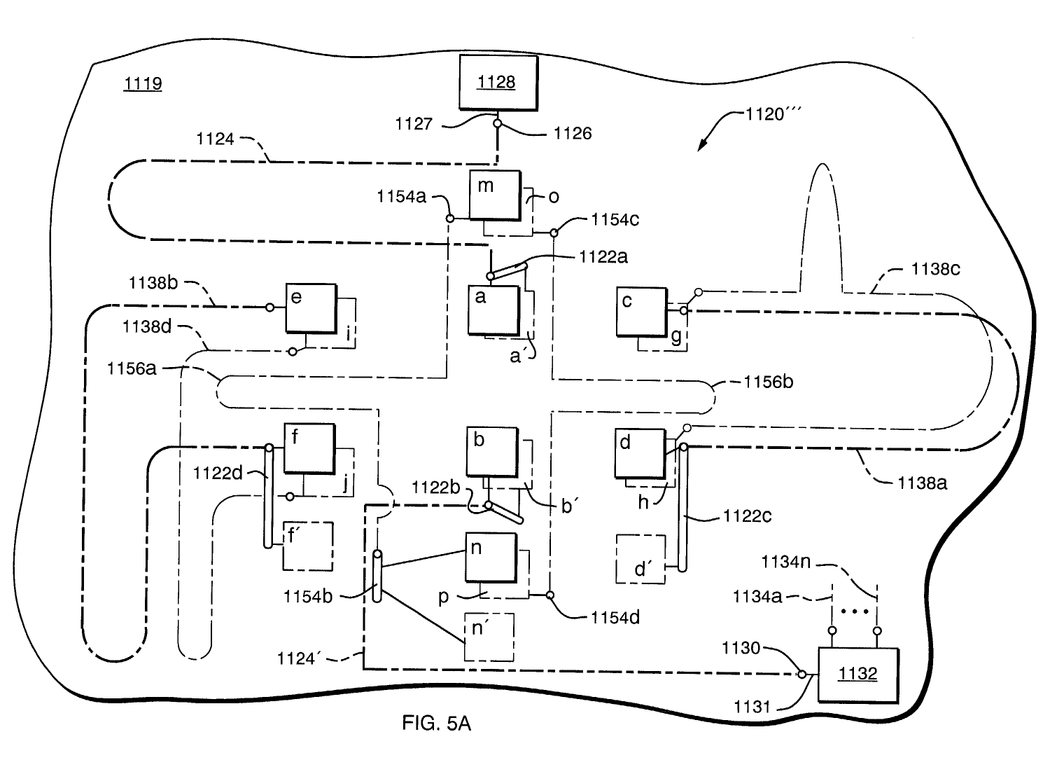

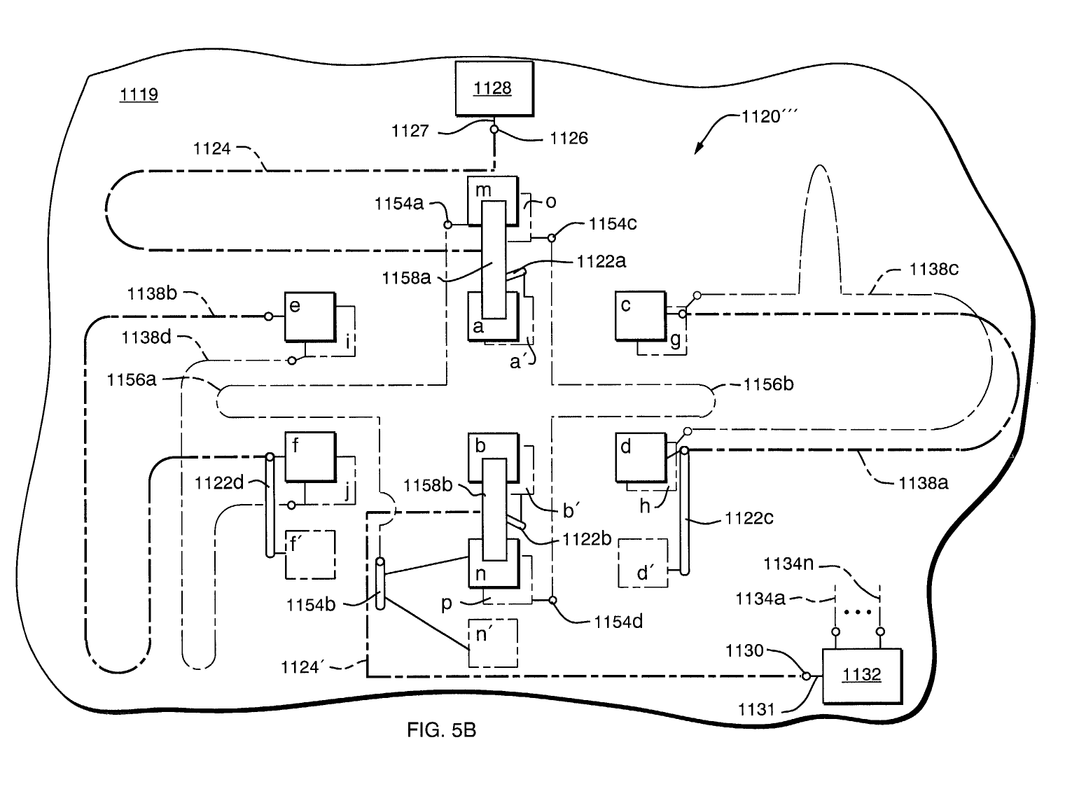

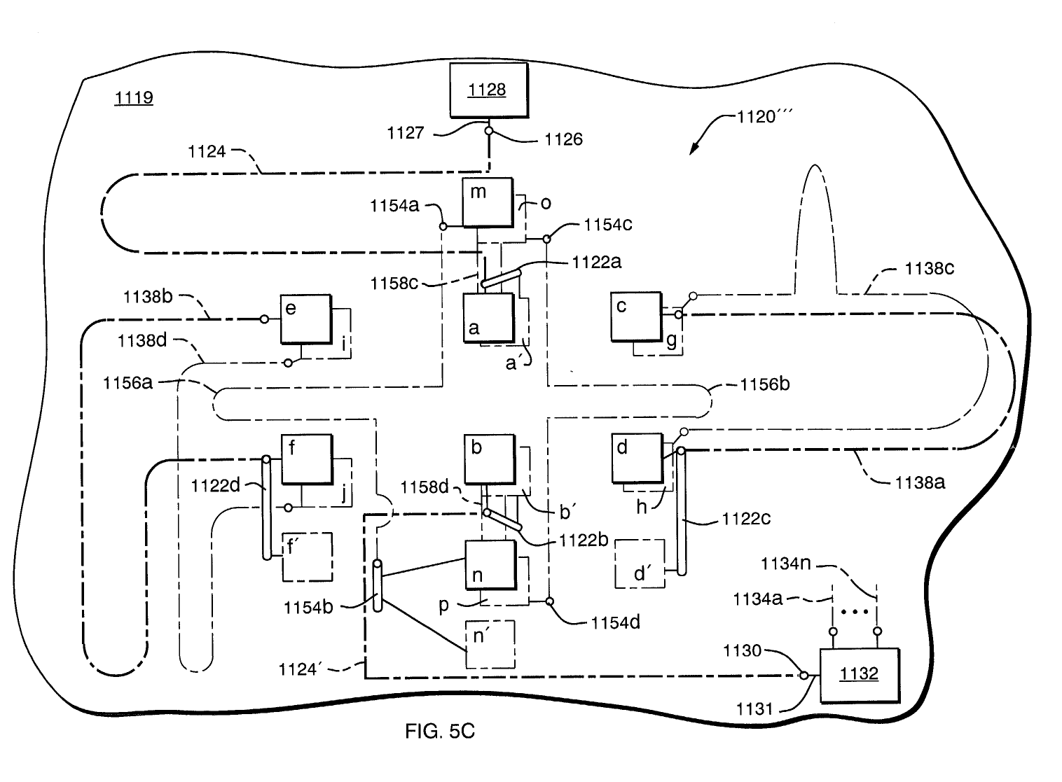

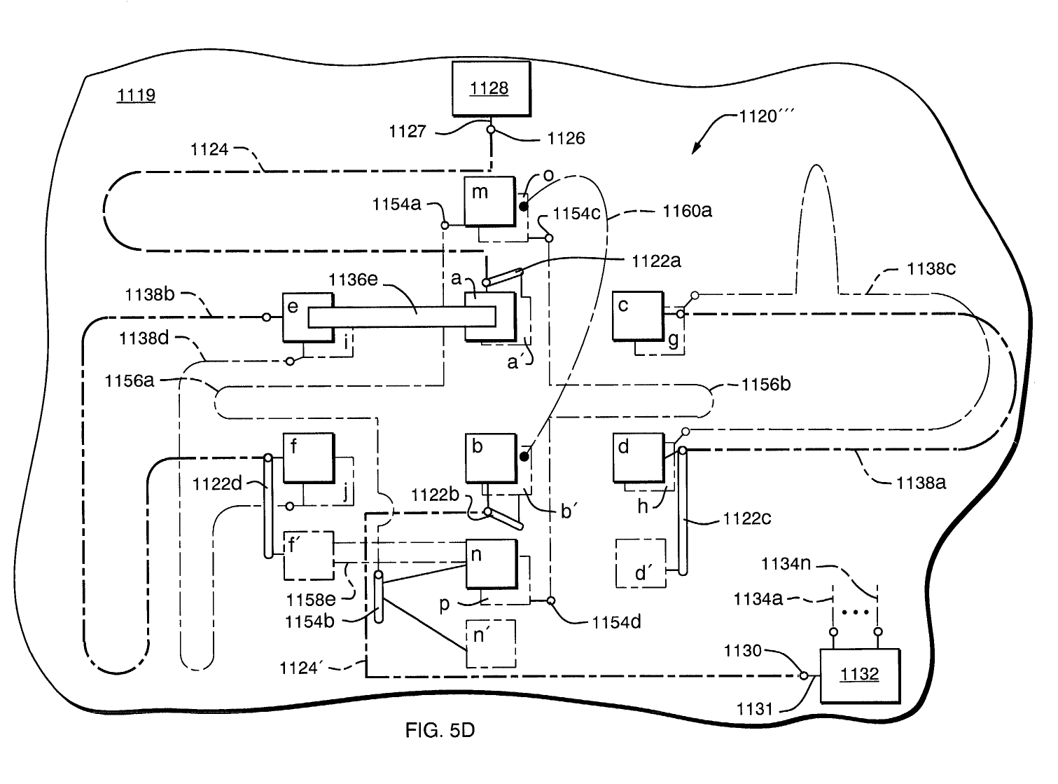

Stacked resistor pads may be used to provide less than the four delay lines of stacked resistor pads 1120 or more delay lines. Referring to FIG. 5a, a stack of resistor pads 1120′″ includes resistor pads a-j, n-p, a′, b′, d′, f′ and n′. Resistor pads a-j, a′, b′, d′ and f′ function as described above with respect to stacked resistor pads 1120. Additional resistor pads m and n are added to the top of the module and are electrically connected together through vias 1154a and 1154b, respectively, and delay line 1156a (e.g., 750 ps). Similarly, additional resistor pads o and p are added to the bottom of the module and are electrically connected together through vias 1154c and 1154d, respectively, and delay line 1156b (e.g., 1250 ps). Resistor pad n′ is added to the bottom of the module and is electrically connected to resistor pad n through via 1154b. As a result, two delay lines 1156a and 1156b are added to the module and the added resistor pads allow for additional delay combinations.

Although not shown, it should be understood that the various minimal delays described above with respect to stacked resistor pads 1120′ and 1120″ (FIGS. 4a-4f) may also be used with stacked resistor pads 1120′″ but are not shown for clarity. In addition, the delay etches are not shown to scale for convenience.

Referring to FIG. 5b, to add delay etch 1156a to signal 1124, 1124′, a resistor 1158a is connected across resistor pads a and m and a resistor 1158b is connected across pads b and n. Referring to FIG. 5c, to add delay etch 1156b to signal 1124, 1124′, a resistor 1158c is connected across resistor pads a′ and o and a resistor 1158d is connected across pads b′ and p. As described above with reference to FIGS. 3f-3n, various other delay combinations are possible. Referring to FIG. 5d, for example, to add delay etch 1138b to delay etch 1156b, resistor 1136e is connected between resistor pads a and e, a resistor 1158e is connected between pads f′ and p and a wire 1160a is connected between pads o and b′.

As a result, six delay lines are made available through stacked resistor pad combination 1120′″ including only eighteen resistor pads and fourteen vias. Currently available resistor pad combinations that provide six delay lines include 24 resistor pads and 24 vias. In addition, the minimal delay through stacked resistor pad combination 1120′″ still includes only 1 resistor while the minimum delay through currently available resistor pad combinations that provide six delay lines include six resistors. Similarly, the maximum delay through stacked resistor pad combination 1120′″ includes only 3 resistors and four wires while the maximum delay through currently available resistor pad combinations that provide six delay lines include twelve resistors. As previously mentioned, reducing the number of resistors/wires and vias reduces the capacitance added to the signal, which reduces potential signal degradation, especially at high-speeds. In addition, lowering the number of resistors/wires lowers the potential for manufacturing defects and errors due to missing or broken parts. Importantly, the stacked resistor pads 1120′″ consume significantly less module surface space than currently available resistor pad combinations that provide six delay etches.

It will be understood that variations and modifications of the above described methods and apparatuses will be apparent to those of ordinary skill in the art and may be made without departing from the inventive concepts described herein. Accordingly, the embodiments described herein are to be viewed merely as illustrative, and not limiting, and the inventions are to be limited solely by the scope and spirit of the appended claims.

1. A stacked resistor pad combination, comprising:
a first set of resistor pads on a first side of a module, including:
a first resistor pad electrically connected to a first via; and
a second resistor pad electrically connected to a second via, wherein the second resistor pad is located in proximity to the first resistor pad; and
a second set of resistor pads on a second side of the module, including:
a third resistor pad electrically connected to the first via; and
a fourth resistor pad electrically connected to the second via, wherein the fourth resistor pad is located in proximity to the third resistor pad.

2. The stacked resistor pad combination of claim 1, wherein the third and fourth resistor pads are located on the second side of the module in a position directly opposite to the location of the first and second resistor pads on the first side of the module.

3. The stacked resistor pad combination of claim 1, wherein the third and fourth resistor pads are located on the second side of the module in a position offset from the location of the first and second resistor pads on the first side of the module.

4. The stacked resistor pad combination of claim 1, wherein the first via is capable of being electrically connected to an output of a first component and wherein the second via is capable of being electrically connected to an input of a second component.

5. The stacked resistor pad combination of claim 1, wherein the first set of resistor pads further includes a fifth resistor pad located in proximity to the first resistor pad and a sixth resistor pad located in proximity to the second resistor pad, wherein the fifth and sixth resistor pads are electrically connected through a first delay line.

6. The stacked resistor pad combination of claim 1, wherein the second set of resistor pads further includes a fifth resistor pad located in proximity to the third resistor pad and a sixth resistor pad located in proximity to the fourth resistor pad, wherein the fifth and sixth resistor pads are electrically connected through a first delay line.

7. The stacked resistor pad combination of claim 1, wherein the first set of resistor pads further includes a fifth resistor pad located in proximity to the first resistor pad and a sixth resistor pad located in proximity to the second resistor pad and wherein the fifth and sixth resistor pads are electrically connected through a first delay line and wherein the second set of resistor pads further includes a seventh resistor pad located in proximity to the third resistor pad and an eighth resistor pad located in proximity to the fourth resistor pad and wherein the seventh and eighth resistor pads are electrically connected through a second delay line.

8. The stacked resistor pad combination of claim 7, wherein the seventh and eighth resistor pads are located on the second side of the module in a position directly opposite to the location of the fifth and sixth resistor pads on the first side of the module.

9. The stacked resistor pad combination of claim 7, wherein the seventh and eighth resistor pads are located on the second side of the module in a position offset from the location of the fifth and sixth resistor pads on the first side of the module.

10. The stacked resistor pad combination of claim 7, wherein the second set of resistor pads further includes a ninth resistor pad and wherein the stacked resistor pad combination further includes a third via electrically connecting the sixth resistor pad to the ninth resistor pad.

11. The stacked resistor pad combination of claim 7, wherein the first set of resistor pads further includes a ninth resistor pad located in proximity to the first resistor pad and a tenth resistor pad located in proximity to the second resistor pad and wherein the ninth and tenth resistor pads are electrically connected through a third delay line and wherein the second set of resistor pads further includes an eleventh resistor pad located in proximity to the third resistor pad and a twelfth resistor pad located in proximity to the fourth resistor pad and wherein the eleventh and twelfth resistor pads are electrically connected through a fourth delay line.

12. The stacked resistor pad combination of claim 11, wherein the eleventh and twelfth resistor pads are located on the second side of the module in a position located directly opposite to the location of the ninth and tenth resistor pads on the first side of the module.

13. The stacked resistor pad combination of claim 11, wherein the eleventh and twelfth resistor pads are located on the second side of the module in a position offset from the location of the ninth and tenth resistor pads on the first side of the module.

14. The stacked resistor pad combination of claim 11, wherein the second set of resistor pads further includes a thirteenth resistor pad and wherein the stacked resistor pad combination further includes a third via electrically connecting the tenth resistor pad to the thirteenth resistor pad.

15. The stacked resistor pad combination of claim 10, wherein the first set of resistor pads further includes a tenth resistor pad located in proximity to the first resistor pad and an eleventh resistor pad located in proximity to the second resistor pad and wherein the tenth and eleventh resistor pads are electrically connected through a third delay line and wherein the second set of resistor pads further includes a twelfth resistor pad located in proximity to the third resistor pad and a thirteenth resistor pad located in proximity to the fourth resistor pad and wherein the twelfth and thirteenth resistor pads are electrically connected through a fourth delay line.

16. The stacked resistor pad combination of claim 15, wherein the second set of resistor pads further includes a fourteenth resistor pad and wherein the stacked resistor pad combination further includes a fourth via electrically connecting the eleventh resistor pad to the fourteenth resistor pad.

17. The stacked resistor pad combination of claim 16, wherein the first set of resistor pads further includes a fifteenth resistor pad located in proximity to the first resistor pad and a sixteenth resistor pad located in proximity to the second resistor pad and wherein the fifteenth and sixteenth resistor pads are electrically connected through a fifth delay line and wherein the second set of resistor pads further includes a seventeenth resistor pad located in proximity to the third resistor pad and an eighteenth resistor pad located in proximity to the fourth resistor pad and wherein the seventeenth and eighteenth resistor pads are electrically connected through a sixth delay line.

18. The stacked resistor pad combination of claim 17, wherein the second set of resistor pads further includes a nineteenth resistor pad and wherein the stacked resistor pad combination further includes a fifth via electrically connecting the sixteenth resistor pad to the nineteenth resistor pad.

19. The stacked resistor pad combination of claim 1, wherein the first set of resistor pads further includes:
a fifth resistor pa d electrically connected to the first resistor pad through a first delay line;
a sixth resistor pad located in proximity to the fifth resistor pad and capable of being electrically connected a first component;
a seventh resistor pad located in proximity to the second resistor pad; and
an eighth resistor pad electrically connected to through a second delay line to the seventh resistor pad, wherein the eighth resistor pad is located in proximity to the sixth resistor pad.

20. The stacked resistor pad combination of claim 19, wherein the second set of resistor pads further includes:
a ninth resistor pad electrically connected to the fourth resistor pad through a third delay line;
a tenth resistor pad located in proximity to the ninth resistor pad and capable of being electrically connected a second component;
an eleventh resistor pad located in proximity to the fourth resistor pad; and
a twelfth resistor pad electrically connected to through a fourth delay line to the eleventh resistor pad, wherein the twelfth resistor pad is located in proximity to the tenth resistor pad.

21. A stacked resistor pad combination, comprising:
a first set of resistor pads on a first side of a module, including:
a first resistor pad electrically connected to a first via, wherein the first via is capable of being electrically connected to an output of a first component;
a second resistor pad electrically connected to a second via, wherein the second via is capable of being electrically connected to an input of a second component and wherein the second resistor pad is located in proximity to the first resistor pad;
a third resistor pad located in proximity to the first resistor pad;
a fourth resistor pad located in proximity to the second resistor pad, wherein the third and fourth resistor pads are electrically connected through a delay line; and
a second set of resistor pads on a second side of the module, including:
a fifth resistor pad electrically connected to the first via; and
a sixth resistor pad electrically connected to the second via, wherein the sixth resistor pad is located in proximity to the fifth resistor pad.

22. A stacked resistor pad combination, comprising:
a first set of resistor pads on a first side of a module, including:
a first resistor pad electrically connected to a first via, wherein the first via is capable of being electrically connected to an output of a first component;
a second resistor pad electrically connected to a second via, wherein the second via is capable of being electrically connected to an input of a second component and wherein the second resistor pad is located in proximity to the first resistor pad; and
a second set of resistor pads on a second side of the module, including:
a third resistor pad electrically connected to the first via; and
a fourth resistor pad electrically connected to the second via, wherein the fourth resistor pad is located in proximity to the third resistor pad;
a fifth resistor pad located in proximity to the third resistor pad; and
a sixth resistor pad located in proximity to the fourth resistor pad, wherein the fifth and sixth resistor pads are electrically connected through a delay line.

23. A stacked resistor pad combination, comprising:
a first set of resistor pads on a first side of a module, including:
a first resistor pad electrically connected to a first via, wherein the first via is capable of being electrically connected to an output of a first component;
a second resistor pad electrically connected to a second via, wherein the second via is capable of being electrically connected to an input of a second component and wherein the second resistor pad is located in proximity to the first resistor pad;
a third resistor pad located in proximity to the first resistor pad;
a fourth resistor pad located in proximity to the second resistor pad, wherein the third and fourth resistor pads are electrically connected through a first delay line;
a fifth resistor pad located in proximity to the first resistor pad;
a sixth resistor pad located in proximity to the second resistor pad, wherein the fifth and sixth resistor pads are electrically connected through a second delay line; and
a second set of resistor pads on a second side of the module, including:
a seventh resistor pad electrically connected to the first via;
an eighth resistor pad electrically connected to the second via, wherein the seventh resistor pad is located in proximity to the eighth resistor pad;
a ninth resistor pad located in proximity to the seventh resistor pad;
a tenth resistor pad located in proximity to the eighth resistor pad, wherein the ninth and tenth resistor pads are electrically connected through a third delay line;
an eleventh resistor pad located in proximity to the seventh resistor pad; and
a twelfth resistor pad located in proximity to the eighth resistor pad, wherein the eleventh and twelfth resistor pads are electrically connected through a fourth delay line.

24. The stacked resistor pad combination of claim 23, wherein the fourth resistor pad is electrically connected to the second delay line through a third via and wherein the second set of resistor pads further includes:
a thirteenth resistor pad electrically connected to the third via.

25. The stacked resistor pad combination of claim 24, wherein the sixth resistor pad is electrically connected to the second delay line through a fourth via and wherein the second set of resistor pads further includes:
a fourteenth resistor pad electrically connected to the fourth via.

26. A stacked resistor pad combination, comprising:
a first set of resistor pads on a first side of a module, including:
a first resistor pad electrically connected to a first via;
a second resistor pad electrically connected to a second via, wherein the second resistor pad is located in proximity to the first resistor pad;
a third resistor pad electrically connected to the first via through a first delay line;
a fourth resistor pad located in proximity to the third resistor pad and capable of being electrically connected to a first component;
a fifth resistor pad located in proximity to the second resistor pad; and
a sixth resistor pad electrically connected through a second delay line to the fifth resistor pad, wherein the sixth resistor pad is located in proximity to the fourth resistor pad; and
a second set of resistor pads on a second side of the module, including:
a seventh resistor pad electrically connected to the first via; and
an eighth resistor pad electrically connected to the second via, wherein the seventh resistor pad is located in proximity to the eighth resistor pad.

27. The stacked resistor pad combination of claim 26, wherein the second set of resistor pads further includes:
a ninth resistor pad electrically connected to the eighth via through a third delay line;
a tenth resistor pad located in proximity to the ninth resistor pad and capable of being electrically connected a second component;
an eleventh resistor pad located in proximity to the eighth resistor pad; and
a twelfth resistor pad electrically connected to through a fourth delay line to the eleventh resistor pad, wherein the twelfth resistor pad is located in proximity to the tenth resistor pad.

28. A stacked resistor pad combination, comprising:
a first set of resistor pads on a first side of a module, including:
a first resistor pad electrically connected to a first via;
a second resistor pad electrically connected to a second via, wherein the second resistor pad is located in proximity to the first resistor pad;
a third resistor pad electrically connected to the first via through a first delay line;
a fourth resistor pad located in proximity to the third resistor pad and capable of being electrically connected to a first component;
a fifth resistor pad located in proximity to the first resistor pad; and
a sixth resistor pad electrically connected through a second delay line to the fifth resistor pad, wherein the sixth resistor pad is located in proximity to the fourth resistor pad; and
a second set of resistor pads on a second side of the module, including:
a seventh resistor pad electrically connected to the first via; and
an eighth resistor pad electrically connected to the second via, wherein the seventh resistor pad is located in proximity to the eighth resistor pad.

29. The stacked resistor pad combination of claim 28, wherein the second set of resistor pads further includes:
a ninth resistor pad electrically connected to the eighth via through a third delay line;
a tenth resistor pad located in proximity to the ninth resistor pad and capable of being electrically connected a second component;
an eleventh resistor pad located in proximity to the eighth resistor pad; and
a twelfth resistor pad electrically connected to through a fourth delay line to the eleventh resistor pad, wherein the twelfth resistor pad is located in proximity to the tenth resistor pad.

30. A method of providing variable delays to a signal through the stacked resistor pad combination of claim 1, including the step of:
forming an electrical connection between the first and second resistor pads.

31. The method of claim 30, wherein forming an electrical connection between the first and second resistor pads includes:
making a direct connection between the first and second resistor pads to provide a minimal delay.

32. The method of claim 31, wherein making a direct connection between the first and second resistor pads comprises:
connecting a resistor, wire or jumper between the first and second resistor pads.

33. The method of claim 30, wherein forming an electrical connection between the first and second resistor pads includes:
making a direct connection between the third and fourth resistor pads to provide a minimal delay.

34. A method of providing variable delays to a signal through the stacked resistor pad combination of claim 21, including the step of:
forming an electrical connection between the first and second resistor pads.

35. The method of claim 34, wherein forming an electrical connection between the first and second resistor pads includes:
making a direction connection between the first and second resistor pads to provide a minimal delay.

36. The method of claim 34, wherein forming an electrical connection between the first and second resistor pads includes:
making a direction connection between the fifth and sixth resistor pads to provide a minimal delay.

37. The method of claim 34, wherein forming an electrical connection between the first and second resistor pads includes:
making a direction connection between the first and third resistor pads; and
making a direction connection between the second and fourth resistor pads to add the delay line to the signal.

38. A method of providing variable delays to a signal through the stacked resistor pad combination of claim 22, including the step of:
forming an electrical connection between the first and second resistor pads.

39. The method of claim 38, wherein forming an electrical connection between the first and second resistor pads includes:
making a direction connection between the first and second resistor pads to provide a minimal delay.

40. The method of claim 38, wherein forming an electrical connection between the first and second resistor pads includes:
making a direction connection between the third and fourth resistor pads to provide a minimal delay.

41. The method of claim 38, wherein forming an electrical connection between the first and second resistor pads includes:
making a direction connection between the third and fifth resistor pads; and
making a direction connection between the fourth and sixth resistor pads to add the delay line to the signal.

42. A method of providing variable delays to a signal through the stacked resistor pad combination of claim 23, including the step of:
forming an electrical connection between the first and second resistor pads.

43. The method of claim 42, wherein forming an electrical connection between the first and second resistor pads includes:
making a direction connection between two or more of the first through the twelfth resistor pads.

44. The method of claim 43, wherein making a direction connection between two or more of the first through the twelfth resistor pads, comprises:
connecting one or more resistors, wires or jumpers between two or more of the first through the twelfth resistor pads.
